(19) United States
(12) Patent Application Publication
(10) Pub. No.: US 2023/0141255 A1
(43) Pub. Date: May 11, 2023

(54) IMAGE DISPLAY DEVICE

(71) Applicant: Sony Group Corporation, Tokyo (JP)

(72) Inventors: Tomoharu Nakamura, Tokyo (JP); Yusuke Oyama, Kanagawa (JP); Akira Tanaka, Kanagawa (JP)

(73) Assignee: Sony Group Corporation, Tokyo (JP)

(21) Appl. No.: 18/090,362

(22) Filed: Dec. 28, 2022

Related U.S. Application Data
(63) Continuation of application No. 16/490,693, filed on Sep. 3, 2019.

(30) Foreign Application Priority Data
Mar. 10, 2017 (JP) 2017-045917

(51) Int. Cl. G02B 5/32; G03B 21/28; G03B 21/56; G03B 37/00; G03H 1/04

(52) U.S. Cl. CPC G02B 5/32; G03B 21/28; G03B 21/56; G03B 37/00; G03H 1/04

(57) ABSTRACT

An image display device according to an embodiment of the present technology include an emission portion, an irradiation target, and an optical portion. The emission portion emits image light along a predetermined axis. The irradiation target is disposed at at least a part around the predetermined axis. The optical portion controls an incident angle of the image light on the irradiation target, the image light having been emitted from the emission portion, the optical portion being disposed in a manner that the optical portion faces the emission portion on the basis of the predetermined axis.

### CROSS-REFERENCE TO RELATED APPLICATIONS

The present application claims the benefit under 35 U.S.C. § 120 as a continuation application of U.S. application Ser. No. 16/490,693, filed on Sep. 3, 2019, which claims the benefit under 35 U.S.C. § 371 as a U.S. National Stage Entry of International Application No. PCT/JP2018/007691, filed in the Japanese Patent Office as a Receiving Office on Mar. 1, 2018, which claims priority to Japanese Patent Application Number JP2017-045917, filed in the Japanese Patent Office on Mar. 10, 2017, each of which applications is hereby incorporated by reference in its entirety.

### TECHNICAL FIELD

The present technology relates to an image display device that displays an image on a screen or the like.

### BACKGROUND ART

Conventionally, technologies of projecting images on a screen or the like having various kinds of shape, have been developed. For example, by projecting an image on the side surface of a cylindrical screen, it is possible to enjoy a whole circumference image that is a 360-degree image displayed omnidirectionally.

Patent Literature 1 describes a whole circumference video forming device for displaying a video on a whole circumference screen having a rotation body shape. With regard to the whole circumference video forming device according to Patent Literature 1, a rotation body reflection mirror is disposed on a ceiling of the whole circumference screen in a manner that a convex surface faces downward. Projection light emitted from a video projection portion that is below the whole circumference screen is reflected by the rotation body reflection mirror toward the whole circumference of the whole circumference screen. This makes it possible to display the video three-dimensionally. (See paragraphs [0025], [0033], [0040], FIG. 1, and the like of Patent Literature 1).

### CITATION LIST

### Patent Literature

Patent Literature 1: JP 2004-12477A

### DISCLOSURE OF INVENTION

### Technical Problem

Such technologies of displaying an image on a whole circumference screen are expected to be applied to wide fields such as advertising and amusement. Therefore, technologies capable of displaying a high-quality image have been desired.

In view of the circumstances as described above, a purpose of the present technology is to provide an image display device capable of displaying a high-quality image on a whole circumference screen or the like.

### Solution to Problem

In order to attain the foregoing object, an image display device according to an embodiment of the present technology include an emission portion, an irradiation target, and an optical portion. The emission portion emits image light along a predetermined axis. The irradiation target is disposed at at least a part around the predetermined axis. The optical portion controls an incident angle of the image light on the irradiation target, the image light having been emitted from the emission portion, the optical portion being disposed in a manner that the optical portion faces the emission portion on the basis of the predetermined axis.

When using this image display device, image light emitted from the emission portion along the predetermined axis is incident on the optical portion that faces the emission portion. The optical portion controls an incident angle of the image light emitted from the emission portion, with respect to the irradiation target. The image light with the controlled incident angle is radiated to the irradiation target disposed at at least a part around the predetermined axis. This makes it possible to display a high-quality image on a whole circumference screen.

The optical portion may set the incident angle of the image light on the irradiation target to be substantially fixed.

Therefore, the irradiation target is irradiated with image light at a substantially fixed incident angle. As a result, it is possible to display a high-quality image on a whole circumference screen.

The optical portion may include a reflection surface that reflects the image light toward the irradiation target, the image light having been emitted from the emission portion.

Therefore, it is possible to easily irradiate the irradiation target with the image light via the reflection surface.

A cross-sectional shape of the reflection surface taken along a plane including the predetermined axis may be configured to include a shape of a parabola that is concave when viewed from the emission portion, and an axis of the parabola may be different from the predetermined axis.

Therefore, for example, beams of the image light reflected by the shape of the parabola become substantially parallel light beams, and it is possible to set angles of incidence on the irradiation target to be substantially fixed. As a result, it is possible to display a high-quality image on a whole circumference screen or the like.

With regard to the reflection surface, the predetermined axis may be parallel to the axis of the parabola included in the cross-sectional shape.

Therefore, for example, by shifting the position of a vertex of the parabola, it is possible to change a position and an incident angle of the image light that is radiated to the irradiation target. Accordingly, it is possible to display a desired image.

With regard to the reflection surface, the predetermined axis may intersect with the axis of the parabola included in the cross-sectional shape, at a vertex of the parabola at a predetermined angle.

Therefore, for example, by adjusting the predetermined angle, it is possible to change the position and the incident angle of the image light that is radiated to the irradiation target. Accordingly, it is possible to display a desired image.

The reflection surface may include a rotation surface obtained by rotating the parabola around the predetermined axis.

Therefore, for example, it is possible to omnidirectionally display an image on a whole circumference screen or the like that is rotationally symmetric around the predetermined axis.

With regard to the reflection surface, an intersection between the rotation surface and the predetermined axis may be protruded when viewed from the emission portion.

Therefore, the vertex of the reflection surface is at a center, and it is possible to thin the periphery of the reflection surface. As a result, it is possible to display an image up to the edge of the whole circumference screen or the like, for example.

With regard to the reflection surface, an intersection between the rotation surface and the predetermined axis may be concave when viewed from the emission portion.

Therefore, the reflection surface includes no protrusion such as the vertex. As a result, for example, the shape of the reflection surface becomes less prominent, and it is possible to naturally display an image.

The optical portion may include one or more refractive surfaces that refract the image light emitted from the emission portion and emits the refracted light toward the irradiation target.

Therefore, it is possible to easily irradiate the irradiation target with the image light by refracting the image light via one or more refractive surface.

The image display device may further include a magnification portion that magnifies the image light emitted from the emission portion and emits the magnified light toward the optical portion, the magnification portion being disposed between the optical portion and the emission portion.

Therefore, for example, it is possible to shorten a distance between the emission portion and the optical portion by magnifying the image light incident on the optical portion, and it is possible to downsize the device.

The image display device may further include a prism portion that changes an optical path of the image light emitted from the optical portion, the prism portion being disposed across the optical portion from the emission portion.

Therefore, it is possible to change the position of incidence, the incident angle, and the like of the image light incident on the irradiation target. Accordingly, it is possible to easily change the position, the size, and the like of the displayed image.

The irradiation target may be disposed over a circumference around the predetermined axis.

Therefore, the whole circumference screen surrounds the predetermined axis, and it is possible to enjoy a whole circumference image and the like.

The irradiation target may be configured to have a cylindrical shape that uses the predetermined axis as its substantially central axis.

This makes it possible to display a high-quality image on a cylindrical whole circumference screen or the like.

The irradiation target may be a hologram screen. For example, the image light is incident on the hologram screen at the adjusted incident angle. As a result, it is possible to display a sufficiently high-quality image.

The irradiation target may be any one of a transmissive screen that transmits the image light and a reflective screen that reflects the image light.

Therefore, it is possible to achieve a whole circumference screen or the like through which a background can be seen, and it is possible to display a see-through whole circumference image or the like.

The irradiation target may emit the image light in a predetermined emission direction, the image light having been incident at the incident angle controlled by the optical portion.

Therefore, for example, it is possible to emit the image light in the emission direction corresponding to a usage environment or the like, and it is possible to achieve high usability.

The irradiation target may include an emission surface that emits the image light. In this case, the predetermined emission direction may intersect with a normal direction of the emission surface at a predetermined intersection angle.

Therefore, for example, it is possible to highly accurately control a direction or the like from which the image can be seen. As a result, it is possible to display a high-quality image on a whole circumference screen or the like.

The irradiation target may be capable of diffusing and emitting the image light. In this case, the predetermined intersection angle may be set on the basis of a diffusion angle of the image light diffused by the irradiation target.

Therefore, for example, it is possible to accurately control optical paths or the like of the image light to be diffused. As a result, it is possible to display a high-quality image on a whole circumference screen or the like.

### Advantageous Effects of Invention

As described above, according to the present technology, it is possible to display a high-quality image on a whole circumference screen or the like. Note that, the effects described herein are not necessarily limited and may be any of the effects described in the present disclosure.

### BRIEF DESCRIPTION OF DRAWINGS

FIG. 1 is an overview diagram illustrating a configuration example of an image display device according to a first embodiment of the present technology.

FIG. 2 is a schematic diagram illustrating a configuration example of a transmissive hologram.

FIG. 3 is a graph showing diffraction efficiency of the transmissive hologram illustrated in FIG. 2.

FIG. 4 is a schematic diagram illustrating a specific configuration example of a reflection mirror.

FIG. 5 is a table showing design parameters of the reflection mirror illustrated in FIG. 4.

FIG. 6 is a schematic diagram illustrating optical paths of image light when using the design parameters illustrated in FIG. 5.

FIG. 7 is a schematic diagram illustrating another configuration example of the reflection mirror.

FIG. 8 is a table showing design parameters of the reflection mirror illustrated in FIG. 7.

FIG. 9 is a schematic diagram illustrating optical paths of image light when using the design parameters illustrated in FIG. 8.

FIG. 10 is an overview diagram illustrating another configuration example of the image display device.

FIG. 11 is an overview diagram illustrating another configuration example of the image display device.

FIG. 12 is an overview diagram illustrating another configuration example of the image display device.

FIG. 13 is an overview diagram illustrating another configuration example of the image display device.

FIG. 14 is an overview diagram illustrating another configuration example of the image display device.

FIG. 15 is an overview diagram illustrating a configuration example of an image display device according to a second embodiment.

FIG. 16 is a schematic diagram for describing a configuration example of a refractive surface.

FIG. 17 is a schematic diagram for describing specific configuration examples of refraction portions.

FIG. 18 is a schematic diagram for describing another example of optical paths of image light from a light source to a refraction portion.

FIG. 19 is a schematic diagram for describing other configuration examples of the optical paths of image light emitted from the refraction portion.

FIG. 20 is a schematic diagram illustrating another configuration example of image shift using a prism.

FIG. 21 is a schematic diagram illustrating another configuration example of the image display device.

FIG. 22 is an overview diagram illustrating a configuration example of an image display device according to another embodiment.

FIG. 23 is an overview diagram illustrating a configuration example of an image display device according to another embodiment.

FIG. 24 is a schematic diagram for describing characteristics of the transmissive hologram.

FIG. 25 is a schematic diagram illustrating examples of the shape of the image display device.

FIG. 26 is a schematic diagram illustrating a configuration example of an image display device according to a comparative example.

FIG. 27 is a graph showing an example of diffraction characteristics of a hologram screen.

### MODE(S) FOR CARRYING OUT THE INVENTION

Hereinafter, embodiments of the present technology will be described with reference to the drawings.

### First Embodiment

[Configuration of Image Display Device]

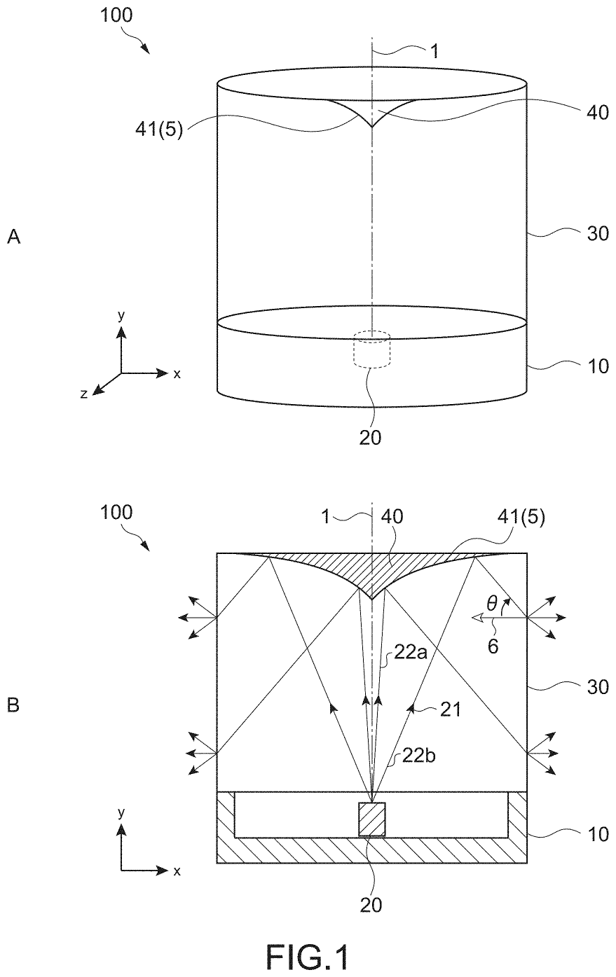

FIG. 1 is an overview diagram illustrating a configuration example of an image display device according to a first embodiment of the present technology. FIG. 1A is a perspective view of an appearance of an image display device 100. FIG. 1B is a cross-sectional view that schematically illustrates a configuration of the image display device 100.

In this embodiment, the description will be given on the assumption that a horizontal direction is a direction of a surface (XZ plane) on which the image display device 100 is disposed, and an up-down direction is a direction (Y direction) that is perpendicular to the horizontal direction. Note that, the present technology is applicable regardless of the direction in which the image display device 100 is disposed.

The image display device 100 includes a base 10, an emission portion 20, a screen 30, and a reflection mirror 40.

The base 10 has a cylindrical shape, and the base 10 is disposed at a bottom of the image display device 100. The base 10 holds the emission portion 20, the screen 30, and the reflection mirror 40 through any holding mechanism (not illustrated). In addition, on the base 10, elements or the like that are necessary to operate the image display device 100 are appropriately disposed, such as an electric power supply source like a battery, a speaker, or another element (that are not illustrated). The shape and the like of the base 10 are not limited. For example, the base 10 has any shape such as a rectangular cuboid shape.

The emission portion 20 is disposed at a substantially center of the cylindrical base 10 in a manner that the emission portion 20 faces upward. The emission portion 20 emits image light 21 along an optical axis 1 that extends in the up-down direction (Y direction). The image light 21 constitutes an image. According to the embodiment, the optical axis 1 corresponds to a predetermined axis.

FIG. 1B illustrates a cross section of the image display device 100 taken along any surface direction including the optical axis 1. The emission portion 20 radially emits the image light 21 along the optical axis 1. Therefore, as illustrated in FIG. 1B, the emission portion 20 emits the image light 21 at a predetermined angle of view on any plane including the optical axis 1. FIG. 1B schematically illustrates an inner optical path 22a that has a small emission angle and is near the optical axis 1, and an outer optical path 22b that has a large emission angle and that is distant from the optical axis 1. Here, the emission angle means an angle between the optical axis 1 and an optical path of light corresponding to each pixel of the image light 21, for example.

As the emission portion 20, a laser scanning color projector or the like is used, for example. The laser scanning color projector scans laser light beams corresponding to respective colors including R, G, and B and displays respective pixels. The specific configuration of the emission portion 20 is not limited. For example, a small mobile projector (pico projector), a projector using monochromatic laser light, or the like may be appropriately used in accordance with the size, use, and the like of the image display device 100. Alternatively, it is also possible to use any projector that is capable of projecting the image light.

For example, as the emission portion 20, a projection device (projector) may be appropriately used. The projection device (projector) includes a light-emitting element and a light-modulating element. The light-emitting element uses a laser diode (LD), a light emitting diode (LED), or the like. The light-modulating element uses microelectromechanical systems (MEMS), the digital micro mirror device (DMD), reflective liquid crystals, transmissive liquid crystals, or the like. In other words, it is possible to use a projection device or the like that includes structural elements such as an LD+MEMS, an LD+DMD, an LD+reflective liquid crystals, an LD+transmissive liquid crystals, an LED+MEMS, an LED+DMD, an LED+reflective liquid crystals, or an LED+transmissive liquid crystals. Of course, the present technology is applicable even in the case of using a projection device including another structural elements.

The screen 30 has a cylindrical shape. The screen 30 is disposed over the circumference around the optical axis 1. In the present embodiment, the screen 30 is provided in a manner that a central axis of the (cylindrical) screen 30 is substantially identical to the optical axis 1 of the emission portion 20. In the example illustrated in FIG. 1A, the diameter of the screen 30 is similar to the diameter of the base 10. Note that, the screen 30 is not limited thereto. The diameter, height, and the like of the screen 30 may be set appropriately. In this embodiment, the screen 30 corresponds to an irradiation target.

The screen 30 is a transmissive hologram disposed over the circumference around the optical axis 1. For example, on the transmissive hologram, an interference pattern of diffused light created through a diffuser panel is recorded. The transmissive hologram has a diffusion function of diffusing the incident image light 21. Note that, the transmissive hologram is not limited thereto. For example, a light diffusion layer or the like may be stacked on an outside (a side opposite to the optical axis 1) of the transmissive hologram that has no diffusion function. The light diffusion layer or the like diffuses image light. In this embodiment, the screen 30 functions as a hologram screen.

The image light 21 is emitted from an inside of the transmissive hologram toward the outside while being diffused (scattered) in various directions through the transmissive hologram. The example in FIG. 1B schematically illustrates the image light 21 that is incident on the transmissive hologram (screen 30), that is diffused (scattered), and that is emitted toward the outside.

The specific configuration of the screen 30 is not limited thereto. For example, it is possible to appropriately use a screen or the like that diffuses light by using a scatterer such as microparticles, a microlens, or the like, for example. Alternatively, it is also possible to use any film or the like that is capable of diffusing the image light 21, as the transmissive screen.

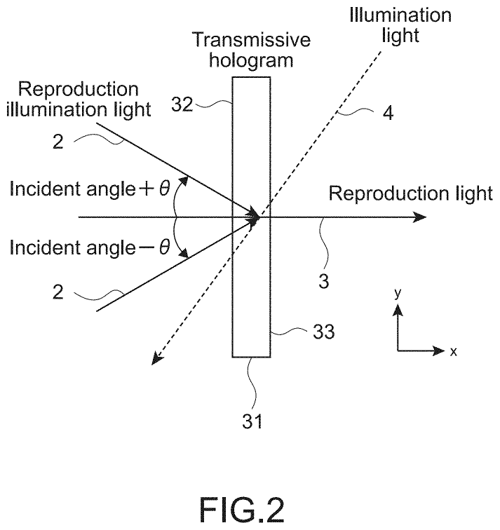

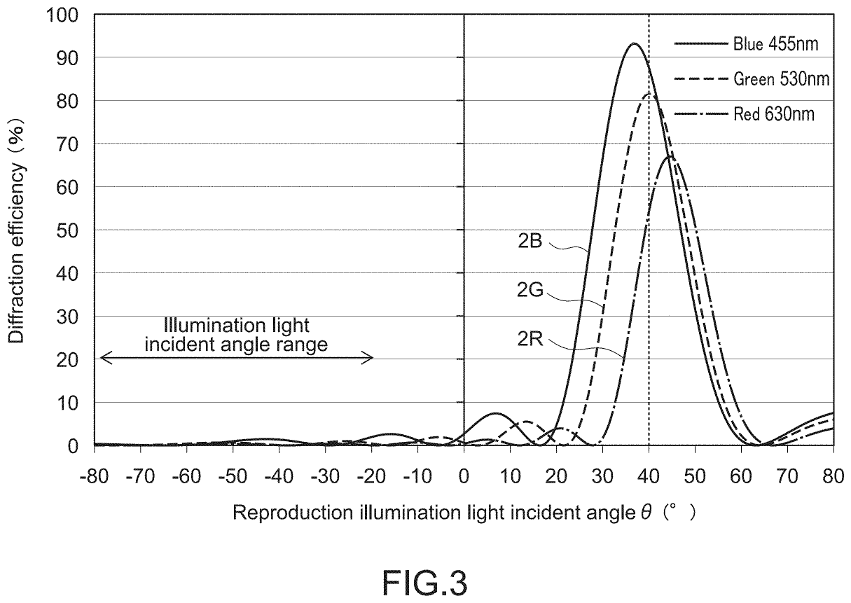

FIG. 2 is a schematic diagram illustrating a configuration example of a transmissive hologram 31. FIG. 3 is a graph showing diffraction efficiency of the transmissive hologram 31 illustrated in FIG. 2. FIG. 2 schematically illustrates reproduction illumination light 2 that is incident on the transmissive hologram 31, and reproduction light 3 that is emitted from the transmissive hologram 31. Note that, in FIG. 2, an incident angle of the reproduction illumination light 2 that is emitted from an upper left side is +θ, and an incident angle of the reproduction illumination light 2 that is emitted from a lower left side is −θ on the basis of an incident angle (θ=zero degree) obtained in the case where the reproduction illumination light 2 is perpendicularly incident on the transmissive hologram 31.

The transmissive hologram 31 includes a first surface 32 on which the reproduction illumination light 2 is incident, and a second surface 33 that emits the reproduction light 3. The first surface 32 corresponds to the inner surface of the screen 30, and the second surface 33 corresponds to the outer surface of the screen 30 in FIG. 1B. For example, the transmissive hologram 31 contains photosensitive material that reacts on a predetermined wavelength or the like. The material or the like of the transmissive hologram 31 is not limited. For example, any photosensitive material or the like may be used. Alternatively, it is also possible to use any holographic optical element (HOE) that functions as the transmissive hologram 31.

For example, as the hologram, it is possible to use material such as photopolymers (photosensitive material or the like) or UV curable resin. By appropriately recording the interference pattern on such material, it is possible to configure a hologram having desired optical functions. In addition, to record the interference pattern, a volume hologram, a relief hologram, or the like is used. The volume hologram forms the interference pattern by using change in refractive index in the material, and the relief hologram forms the interference pattern by using the concave-convex surface of the material, for example. For example, a method of exposing the photosensitive material and recording the interference pattern is an example of a method of configuring the volume transmissive hologram 31.

In addition, for example, the screen 30 (hologram screen) illustrated in FIG. 1 is configured by a hologram film. The hologram film is thin film-like material. For example, the hologram film includes a base film to which photopolymers are applied. The hologram film is exposed via the interference pattern by attaching the hologram film to a substrate having high flatness such as glass, for example. The cylindrical screen 30 is obtained by removing the hologram on which the interference pattern is recorded from the substrate, and attaching the hologram film to transparent base material (transparent cylindrical base material) having a cylindrical shape. Note that, illustration of the transparent cylindrical base material is omitted in FIG. 1 and FIG. 2.

For example, the hologram film (transmissive hologram 31) is attached to an inside or an outside of the cylindrical base material. In other words, the hologram film is disposed on an incident side of the reproduction illumination light 2, and the transparent cylindrical base material is disposed on an emission side of the reproduction light 3. Alternatively, the transparent cylindrical base material is disposed on the incident side of the reproduction illumination light 2, and the hologram film is disposed on the emission side of the reproduction light 3. Accordingly, it is easily obtain the cylindrical screen 30 using the transmissive hologram 31.

Alternatively, for example, it is also possible to directly apply the photopolymers or the like to the transparent cylindrical base material. In this case, a hologram layer containing the photopolymers is formed on the inside or the outside of the transparent cylindrical base material. In other words, the hologram layer is formed on the incident side of the reproduction illumination light 2, and the transparent cylindrical base material is disposed on the emission side of the reproduction light 3. Alternatively, the transparent cylindrical base material is disposed on the incident side of the reproduction illumination light 2, and the hologram layer is formed on the emission side of the reproduction light 3. It is possible to adopt the above-described configurations.

For example, it is possible to expose the photopolymers via the interference pattern in a state where the photopolymers are applied to the transparent cylindrical base material. Therefore, the base film is not necessary, and it is possible to reduce the number of parts. In addition, the attachment process is not necessary, and it is possible to simplify the manufacturing procedure. Therefore, it is possible to suppress cost or the like of manufacturing the screen 30. In addition, the type of the hologram, the method of forming the screen 30, and the like are not limited. Next, the description will be given while using the volume transmissive hologram 31 as an example. Of course, the present technology is applicable even in the case of using another type of the hologram or the like.

The transmissive hologram 31 illustrated in FIG. 2 is exposed to reference light and object light having an exposure wavelength of approximately 530 nm. The object light is incident on the first surface 32 from a direction in which an incident angle θ is approximately zero degree. The reference light is incident on the first surface 32 in a direction in which an incident angle θ is approximately 40 degrees. In such a way, an interference pattern is recorded on the photosensitve material by using the object light and the reference light, and a transmissive hologram is generated.

FIG. 3 illustrates a relation between diffraction efficiency and incident angles of the reproduction illumination light. A horizontal axis of the graph represents the incident angles θ of the reproduction illumination light. In addition, a vertical axis of the graph represents the diffraction efficiencies (%) at the respective incident angles θ. The diffraction efficiency is calculated on the basis of a ratio between light intensity of the reproduction light 3 and light intensity of the reproduction illumination light 2 (reproduction light intensity/reproduction illumination light intensity), for example. Note that, in the graph illustrated in FIG. 3, a solid line represents diffraction efficiencies obtained in the case where blue light 2B (wavelength of 455 nm) is used as the reproduction illumination light 2, a dotted line represents diffraction efficiencies obtained in the case where green light 2G (wavelength of 530 nm) is used as the reproduction illumination light 2, and a dash-dotted line represents diffraction efficiencies obtained in the case where red light 2R (wavelength of 630 nm) is used as the reproduction illumination light 2.

For example, the maximum diffraction efficiency is obtained at the incident angle of 40 degrees in the case where the green light 2G is used as the reproduction illumination light 2. The green light 2G has a wavelength that is similar to a wavelength used for exposing the transmissive hologram 31. In other words, with regard to the transmissive hologram 31, the green light 2G (reproduction light 3) that has been perpendicularly emitted from the second surface 33 has the maximum intensity (luminance) in the case where the green light 2G (reproduction illumination light 2) is incident on the first surface 32 at an incident angle of 40 degrees.

In addition, at an angle that is similar to the incident angle used for the exposure, the diffraction efficiency reaches a peak (θ=approximately 45 degrees) in the case where the red light 2R is incident, and the diffraction efficiency reaches a peak (θ=approximately 37 degrees) in the case where the blue light 2B is incident. Therefore, for example, it is possible to increase luminances of the respective color light beams by emitting the reproduction illumination light 2 at an incident angle θ of near 40 degrees.

As described above, the reproduction illumination light 2 (image light) is incident at a fixed incident angle θ in accordance with an incident angle θ of the reference light emitted when exposing the transmissive hologram 31. Therefore, it is possible to display a luminous image or the like through the transmissive hologram 31. Note that, the incident angles or the like of the reference light and the object light used when exposing the transmissive hologram 31 are not limited to the above-described example. The incident angles and the like may be appropriately set in accordance with a use purpose of the image display device 100, characteristics of the transmissive hologram, and the like.

On the other hand, in the case where the incident angle θ is a negative value, the diffraction efficiencies of the blue light 2B, the green light 2G, and the red light 2R are low values. In other words, the transmissive hologram 31 is transparent to the reproduction illumination light 2 at the incident angle θ of a negative value (the reproduction illumination light 2 incident from the lower left side in FIG. 2) regardless of wavelength.

With regard to the transmissive hologram 31, it may be considered that the interference pattern is an incident-angle-dependent mirror. In other words, the interference pattern is transparent to light that is not diffracted by the interference pattern, regardless of its incident direction. Therefore, the transmissive hologram 31 is also transparent to outside light incident on the second surface 33 from an upper right side that is opposite to the direction of the reproduction illumination light 2 incident from the lower left side in FIG. 2.

For example, in the case where an interior light such as a fluorescent lamp is disposed on the upper right side, it is considered that illumination light 4 is incident on the second surface 33 of the transmissive hologram 31 as illustrated in FIG. 2. For example, in the case where the illumination light 4 is emitted obliquely from the upper right side in a range between approximately −80 degrees and −20 degrees with regard to the incident angle θ of the reproduction illumination light 2, the color light beams R, G, and B included in the illumination light 4 are hardly affected by the diffraction due to the interference pattern. Therefore, the transmissive hologram 31 is substantially transparent to the illumination light 4.

The reflection mirror 40 includes a reflection surface 41 that reflects the image light 21 emitted from the emission portion 20. The reflection mirror 40 is disposed in a manner that the reflection surface 41 faces the emission portion 20 on the basis of the optical axis 1.

In this embodiment, the reflection surface 41 has a rotationally symmetric shape around the optical axis 1. Specifically, the reflection surface 41 includes a rotation surface 5 obtained by rotating a curve around the optical axis 1. The curve is obtained by cutting out a part of a parabola. The rotation surface 5 is configured in a manner that a concave side of the parabola (a focus side of the parabola) serves as a light reflection side (reflection surface 41) and the axis of the parabola is different from the optical axis 1.

As illustrated in FIG. 1B, the reflection surface 41 according to the embodiment has a shape in which its vertex is on the optical axis 1. In other words, with regard to the reflection surface 41, an intersection between the rotation surface 5 and the optical axis 1 protrudes when viewed from the emission portion 20. In addition, with reference to a cross-sectional shape of the reflection mirror 40, a left curve and a right curve are disposed with the optical axis 1 interposed therebetween, and each of the curves has a parabola shape that is concave when viewed from the emission portion 20.

The specific configuration and the like of the reflection mirror 40 are not limited. For example, any material including resin such as acrylic resin, glass, metal, or the like may be used as material constituting the reflection mirror 40. For example, the reflection mirror 40 is obtained by performing mirror-like finishing on a surface of such material and obtaining surface roughness Ra that is approximately less than 0.1 μm. Alternatively, for example, any material may be used for the reflection mirror 40 in accordance with processing accuracy, productivity, and the like.

Alternatively, for example, it is also possible to apply a high-reflection coating or the like to the reflection surface 41 of the reflection mirror 40. For the high-reflection coating, a thin aluminum film, a thin silver film, or the like is used. Therefore, it is possible to highly efficiently reflect the image light 21 incident on the reflection surface 41. Alternatively, it is also possible to appropriately apply a protective coating or the like to the surface of the reflection surface 41. The protective coating is for protecting the reflection surface 41 by using a thin film such as an SiO2 film, a polymerized film, or the like. In addition, material and the like of the high-reflection coating and the protective coating are not limited.

The image light 21 radially emitted upward from the emission portion 20 is reflected by the reflection surface 41 of the reflection mirror 40 in a manner that the image light 21 radially goes toward the whole circumference of the screen 30. As described above, the reflection surface 41 includes the rotation surface 5 having the parabola shape. Therefore, as illustrated in FIG. 1B, the image light 21 reflected by the rotation surface 5 is incident on the screen 30 at the substantially fixed incident angles θ.

Here, the incident angles θ are angles of incident directions (such as directions of respective optical paths 22a and 22b) of beams of the image light 21 with respect to a normal direction (an arrow 6 illustrated in FIG. 1B) at incident points of the beams of the image light 21 on the screen 30. With reference to the cross section including the optical axis 1, the image light 21 is reflected by the left side and the right side of the reflection surface 41 that are disposed with the optical axis 1 interposed therebetween, and the reflected image light 21 is emitted toward the screen 30 as substantially parallel light beams.

The reflection mirror 40 according to the embodiment functions as an optical portion that controls the incident angles of the image light 21 emitted from the emission portion 20, with respect to the screen 30. Specifically, the reflection mirror 40 controls the incident angles of the image light 21 incident on the screen 30 in a manner that the incident angles are substantially fixed.

Note that, in the present disclosure, the substantially fixed incident angles θ include an incident angle θ that falls within an angle range (allowable angle range) capable of appropriately displaying an image. The allowable angle range is set in accordance with diffraction characteristics of the hologram screen (screen 30), for example.

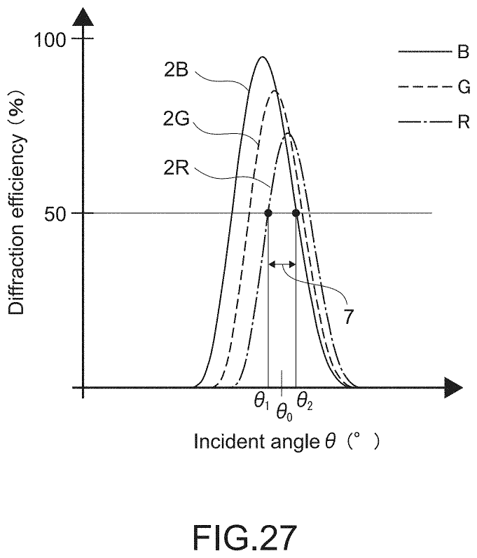

FIG. 27 is a graph showing an example of the diffraction characteristics of the hologram screen. FIG. 27 illustrates the schematic graphs that show diffraction efficiencies of the respective color light beams R, G, and B. With regard to the hologram screen, peak positions of the diffraction efficiencies of the respective color light beams are different from each other. The peak angles get larger in ascending order of wavelength. The light beams arranged in ascending order of wavelength are the blue light 2B (solid line), the green light 2G (dotted line), and the red light 2R (dash-dotted line). Note that, in the range in which the graphs of the respective color light beams overlap with one another, the three color light beams of R, G, and B are independently diffracted with their diffraction efficiencies.

An allowable angle range 7 is set to an angle range in which the diffraction efficiencies of all the color light beams of R, G, and B on the hologram screen are a predetermined value or more, for example. For example, an arrow in FIG. 27 represents the allowable angle range 7 (θ₁≤θ≤θ₂) in which diffraction efficiencies exceed 50%. Here, in the range in which the graphs of the respective color light beams overlap with one another, θ₁ represents an angle at which the diffraction efficiency of the red light 2R is 50%, and θ₂ represents an angle at which the diffraction efficiency of the blue light 2B is 50%. As illustrated in FIG. 27, diffraction efficiencies of all the color light beams of R, G, and B are 50% or more in the range of θ₁≤θ≤θ₂.

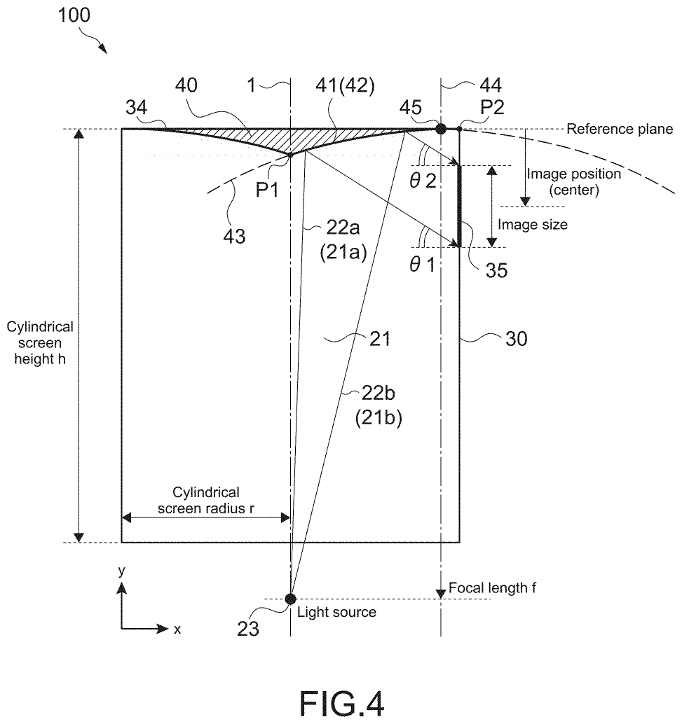

In addition, it is possible to represent the allowable angle range 7 as θ₀±d, where θ₂−θ₁=2d, and θ₀ is an intermediate value between θ₁ and θ₂. For example, in the case of the hologram screen (transmissive hologram 31) having the diffraction efficiencies illustrated in FIG. 4, the allowable angle range 7 in which diffraction efficiencies of all the color light beams of R, G, and B are 50% or more is 47°±4°. Therefore, 50% or more of the image light 21 incident on the hologram screen is diffracted in the allowable angle range 7. Accordingly, it is possible to properly display an image. In this case, the substantially fixed incident angles θ include incident angles θ of 47°±4°, and substantially parallel light beams include light incident at the incident angles θ of 47°±4°.

Note that, it is possible to appropriately design the diffraction characteristics of the hologram screen in accordance with a use purpose and the like of the image display device 100. For example, it is possible to design a hologram having various kinds of adjusted parameters such as peak positions of diffraction efficiencies of the respective color light beams R, G, and B, and a width of angle distribution of the diffraction efficiencies of the respective color light beams, and the like. The allowable angle range 7 may be appropriately set in accordance with such designs in a manner that a desired display property and the like are exhibited.

A method of setting the allowable angle range 7 and the like is not limited. In the above description, the diffraction efficiency of 50% is used as a reference. However, for example, it is also possible to set the allowable angle range 7 on the basis of the diffraction efficiency of 40%, 30%, or the like. In addition, for example, on the basis of the intermediate value θ₀, it is possible to appropriately set an angle range of the intermediate value θ0±5% or an angle range of the intermediate value θ0±10% as the allowable angle range 7. In addition, it is possible to set the allowable angle range 7 on the basis of the incident angle θ of the reference light incident at the time of hologram exposure as described with reference to FIG. 3 and the like, instead of the intermediate value θ₀.

As described above, the reflection mirror 40 controls the incident angles θ of the image light 21 in a manner that the incident angles θ fall within the allowable angle range 7 depending on the diffraction characteristics of the screen 30. In other words, the incident angles θ of the image light 21 incident on the screen 30 are controlled in a manner that the incident angles θ fall within a range capable of assuring output (diffraction efficiency) of 50%, for example. Alternatively, in another respect, it can be said that control accuracy of the incident angles θ (parallel levels or the like of substantially parallel light beams) is decided in accordance with the diffraction characteristics of the screen 30.

FIG. 4 is a schematic diagram illustrating a specific configuration example of the reflection mirror 40. FIG. 4 schematically illustrates cross-sectional shapes of the reflection mirror 40 (reflection surface 41) and the screen 30 taken along any surface direction including the optical axis 1. In addition, in FIG. 4, a dashed line schematically represents a parabola 43 constituting a curve 42 included in the cross-sectional shape of the reflection surface 41. For example, it is possible to appropriately set the shape and the like of the reflection surface 41 on the basis of the direction, the position, the shape, and the like of the parabola 43 (such as curvature or a focal length of the parabola, for example).

For example, it is possible to represent the direction of the parabola 43 by using a direction of an axis 44 of the parabola (an axis of symmetry of the parabola). With regard to the reflection mirror 40 illustrated in FIG. 4, the reflection surface 41 is configured in a manner that the optical axis 1 is parallel to the axis 44 of the parabola. Therefore, the parabola 43 constituting the cross section of the reflection surface 41 has the axis of symmetry that is parallel to the Y axis direction, and the parabola 43 is convex upward. Accordingly, the direction of the parabola 43 (direction of a vertex 45) is an upward direction.

For example, it is possible to represent the position of the parabola 43 by using the position of the vertex 45 of the parabola. In FIG. 4, the vertex 45 of the parabola is disposed at a position shifted from the position of the optical axis 1 on a plane (hereinafter, referred to as a reference plane 34) including an upper end of the cylindrical screen 30. In other words, the vertex 45 of the parabola 43 is disposed on a line connecting an upper left end to an upper right end of the cross-sectional shape of the screen 30. The present disclosure is not limited thereto. It is possible to appropriately set the position of the vertex 45 of the parabola.

The shape of the parabola 43 is decided on the basis of a focal length f or the like. In general, curvature of the parabola 43 becomes larger as the focal length f increases, and curvature of the parabola 43 becomes smaller as the focal length f decreases. In FIG. 4, a distance between a light source 23 (the emission portion 20) of the image light 21 and the upper end (the reference plane 34) of the screen 30 is the same as the focal length f of the parabola 43. The present disclosure is not limited thereto. It is possible to appropriately set the shape (focal length f) and the like of the parabola 43.

Note that, the position of the light source 23 corresponds to the position of a point light source on the assumption that the point light source emits the image light 21 that is emitted from the emission portion 20, for example. Therefore, for example, it is possible to deem the light beams (image light 21) radially emitted from the emission portion 20 as light beams whose emission start points are the light source 23. For example, it is possible to appropriately set the position of the light source 23, the shape of the parabola 43, and the like in accordance with the configuration and the like of the emission portion 20.

For example, the reflection surface 41 is obtained by rotating the curve 42 around the optical axis 1. The curve 42 connects a point P1 and a point P2. At the point P1, the parabola 43 intersects with the optical axis 1. At the point P2, the parabola 43 intersects with the screen 30. Note that, the diameter and the like of the reflection surface 41 are not limited. For example, the length and the like of the curve 42 of the parabola 43 may be appropriately set in a manner that the diameter of the reflection surface 41 is smaller than a radius r of the cylindrical screen, for example.

As illustrated in FIG. 4, image light 21a emitted from the light source 23 along the inner optical path 22a is reflected by the reflection surface 41 and is incident on the screen 30 at the incident angle θ1. In addition, image light 21b emitted along the outer optical path 22b is reflected by the reflection surface 41 and is incident on the screen 30 at the incident angle θ2. As described above, the respective incident angles of the image light 21a and the image light 21b that have been emitted along the inner optical path 22a and the outer optical path 22b are substantially fixed (θ1≈θ2). In other words, the image light 21a is parallel to the image light 21b on the cross section including the optical axis 1.

In a similar way, beams of image light 21 that pass through other optical paths between the inner optical path 22a and the outer optical path 22b are reflected by the reflection surface 40 and are incident on the screen 30 at the substantially fixed incident angles. The screen 30 and the reflection mirror 40 have rotationally symmetric shapes with respect to the optical axis 1. Therefore, for example, the image light 21 emitted along another cross section including the optical axis 1 is also incident on the screen 30 at the substantially fixed incident angles in a way similar to the image light illustrated in FIG. 4. As a result, the incident angles of the image light incident on the screen 30 are substantially fixed regardless of an up-down position or an azimuth of the screen 30.

The image light 21 incident on the screen 30 at the substantially fixed incident angles passes through the transmissive hologram, and the image light 21 is diffused and emitted toward the outside of the screen 30. This makes it possible to display an image such as a whole circumference image on the outside of the screen 30.

In FIG. 4, a bold line represents a display range 35 of the image on the cross section of the screen 30. For example, it is considered that the image is displayed by using the image light 21a that passes through the inner optical path 22a, the image light 22b that passes through the outer optical path 22b, and the image light 21 that passes through the other optical paths interposed between the optical paths 22a and 22b. In this case, as illustrated in FIG. 4, the image light 21a that passes through the inner optical path 22a displays a lower end of the image, and the image light 21b that passes through the outer optical path 22b displays an upper end of the image. In other words, a length between an incident point of the image light 21a and an incident point of the image light 21b is deemed to be an image size (a width of the image in the up-down direction).

For example, the image size is decided on the basis of an angle between the inner optical path 22a and the outer optical path 22b and the incident angles of the image light 21. In addition, a display position of the image is decided on the basis of the radius r of the screen 30, for example. In FIG. 4, arrows schematically represent the image size and a central position of the image.

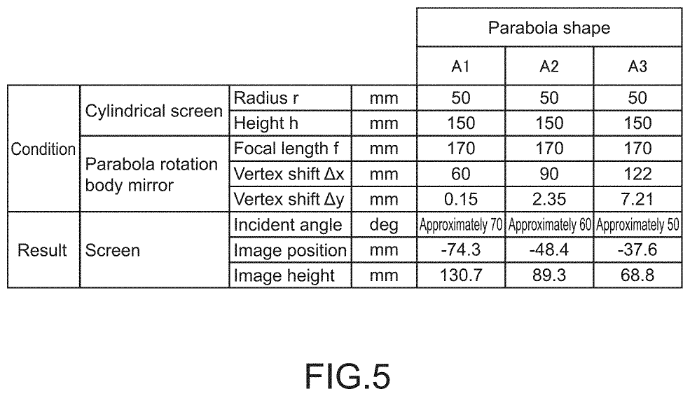

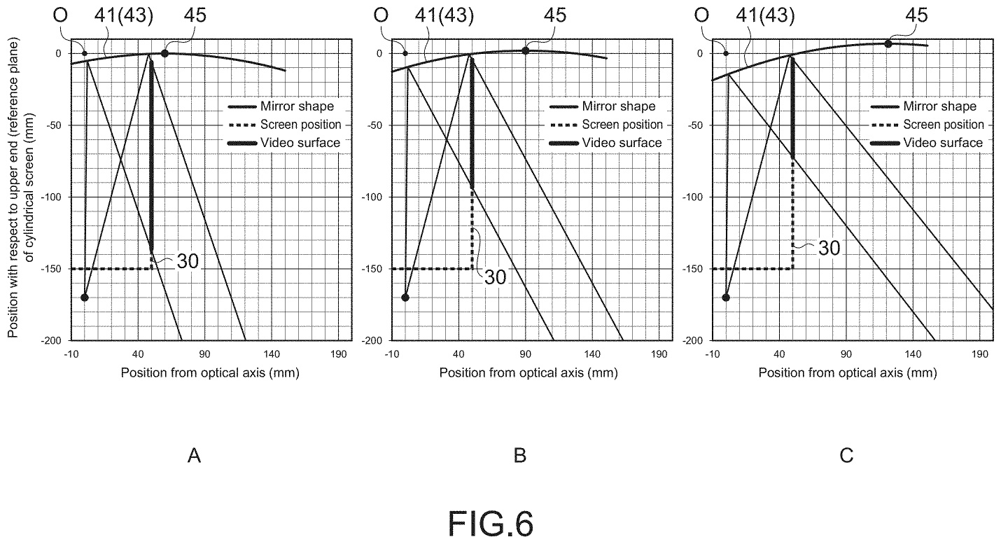

FIG. 5 is a table showing design parameters of the reflection mirror 40 illustrated in FIG. 4. FIG. 6 is a schematic diagram illustrating optical paths of image light when using the design parameters illustrated in FIG. 5. FIG. 5 illustrates design parameters A1 to A3 of the reflection mirror. FIG. 6A to FIG. 6C are schematic diagrams illustrating optical paths of the image light and reflection surfaces 41 (parabolas 43) when using the design parameters A1 to A3. For ease of explanation, FIG. 6A to FIG. 6C illustrate the optical paths of the image light on the right half of the screen 30.

In accordance with the design parameters A1, A2, and A3, positions of the vertex 45 of the parabola 43 are decided in a manner that incident angles of the image light are approximately 70 degrees, approximately 60 degrees, and approximately 50 degrees, respectively. Note that, with regard to the design parameters A1 to A3, the radius r of the screen 30 is 50 mm, the height h of the screen 30 is 150 mm, and the focal length f of the parabola 43 is 170 mm. Note that, the positions of the light source 23 and emission angles (angles of view) of the image light are fixed.

FIG. 5 illustrates positions of the vertex 45 of the parabola 43 on the basis of an intersection (origin O) between the optical axis 1 and the reference surface 34. In other words, the vertex 45 is deemed as a shift amount of the vertex from the origin O in a left-right direction (X direction) and the up-down direction (Y direction).

In the case of the design parameter A1, a shift amount ΔX of the vertex O of the parabola 43 in the X direction is 60 mm, and a shift amount ΔY in the Y direction is 0.15 mm. The incident angles of the image light is set to approximately 70 degrees when using the above-described parabola 43. As illustrated in FIG. 6A, it is possible to display the image up to a position close to the lower end of the screen 30 when setting the incident angles to approximately 70 degrees. When using the design parameter A1, the height of the image (the size in the up-down direction) is 130.7 mm, and the display position of the image is −74.3 mm.

In the case of the design parameter A2, a shift amount ΔX of the vertex 45 in the X direction is 90 mm, and a shift amount ΔY in the Y direction is 2.35 mm. As illustrated in FIG. 6B, it is possible to display a smaller image when setting the incident angles to approximately 60 degrees, in comparison with the case of using the design parameter A1. When using the design parameter A2, the height of the image (the size in the up-down direction) is 89.3 mm, and the display position of the image is −48.4 mm.

In the case of the design parameter A2, a shift amount ΔX of the vertex 45 in the X direction is 122 mm, and a shift amount ΔY in the Y direction is 7.21 mm. As illustrated in FIG. 6C, for example, it is possible to display an image on only an upper side of the screen 30 when setting the incident angles to approximately 50 degrees. When using the design parameter A3, the height of the image (the size in the up-down direction) is 68.8 mm, and the display position of the image is −37.6 mm.

As described above, it is easily control values of the incident angles by shifting the vertex 45 of the parabola 43 whose axis of symmetry is parallel to the optical axis 1. The design parameters such as the shift amounts of the respective vertices 45 are not limited. For example, it is possible to appropriately set a shift amount and the like of the vertex 45 in accordance with a desired image size, a desired image position, and the like.

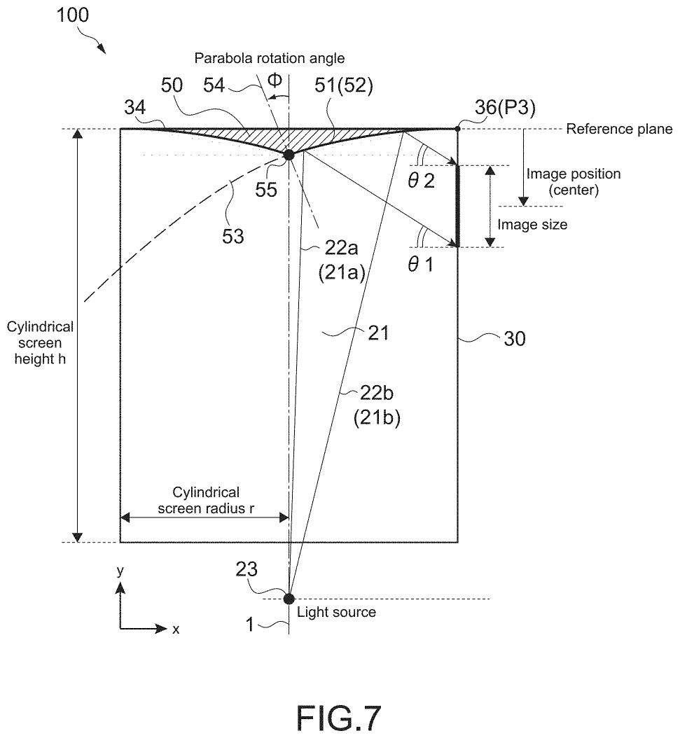

FIG. 7 is a schematic diagram illustrating another configuration example of the reflection mirror 40. FIG. 7 schematically illustrates cross-sectional shapes of a reflection mirror 50 (reflection surface 51) and the screen 30 taken along any surface direction including the optical axis 1. In addition, in FIG. 7, a dashed line schematically represents a parabola 53 constituting a curve 52 included in the cross-sectional shape of the reflection surface 51. With regard to the reflection mirror 50 illustrated in FIG. 7, the direction of an axis 54 of the parabola 53 and the position of a vertex 55 of the parabola 53 are different from the reflection mirror 40 illustrated in FIG. 4.

As the parabola 53 constituting the curve 52, the reflection surface 51 of the reflection mirror 50 uses the parabola 53 rotated while a normal direction of the cross section is used as a rotation axis direction. Specifically, the parabola 53 having the vertex 55 that faces upward is rotated around the vertex 55 at a rotation angle Φ in a state where the axis 54 of the parabola is identical to the optical axis 1. Therefore, the optical axis 1 intersects with the axis 54 of the parabola 53 at the rotation angle Φ. In this embodiment, the rotation angle Φ corresponds to the predetermined angle.

The position (Y-coordinate) of the vertex 55 of the parabola 53 in the up-down direction is set in accordance with the reference plane 34 of the screen 30. In the example illustrated in FIG. 7, the position of the vertex 55 of the parabola 53 is set in a manner that the curve 52 intersects with the upper right end of the screen 30. The curve 52 is on the right side of the parabola 53 that is located across the vertex 55 from the left side of the parabola 53. Note that, the vertex 55 is disposed on the optical axis 1. Therefore, a position (X-coordinate) in the left-right direction is not changed.

The reflection surface 41 (rotation surface) is obtained by rotating the curve 52 around the optical axis 1. The curve 52 connects the vertex 55 and the parabola 53 to a point P3 at which the parabola 53 intersects with the screen 30 (the upper right end 36 of the screen 30). The length and the like of the curve 52 are not limited.

As illustrated in FIG. 7, the image light 21a and the image light 21b are emitted from the light source 23 along the inner optical path 22a and the outer optical path 22b, and are incident on the reflection surface 51 of the reflection mirror 50. The respective beams of the image light incident on the reflection surface 51 are reflected toward the screen 30 in a manner that the respective beams of the image light are substantially parallel to each other in a cross section. Therefore, the incident angle θ1 and the incident angle θ2 of the image light 21a and the image light 21b are substantially fixed (θ1≈θ2) with respect to the screen 30. In a similar way, beams of image light 21 that pass through other optical paths between the inner optical path 22a and the outer optical path 22b are reflected by the reflection mirror 50, and are incident on the screen 30 at the substantially fixed incident angles. This makes it possible to display a whole circumference image on the outside of the screen 30.

As described above, even in the case where the axis of the parabola 53 constituting the reflection surface 51 is rotated (inclined) with respect to the optical axis 1, it is possible to reflect the image light 21 in a manner that the incident angles of the image light 21 are substantially fixed with respect to the screen 30.

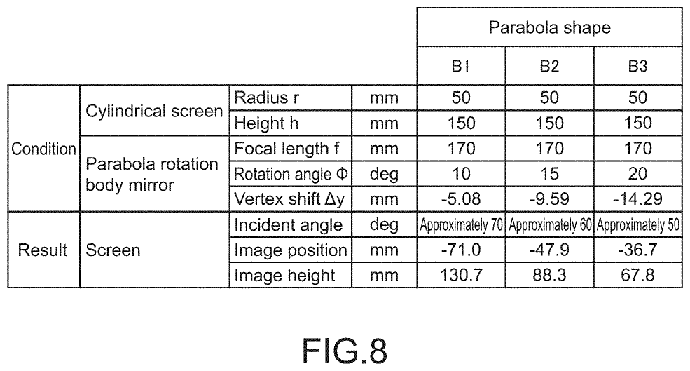

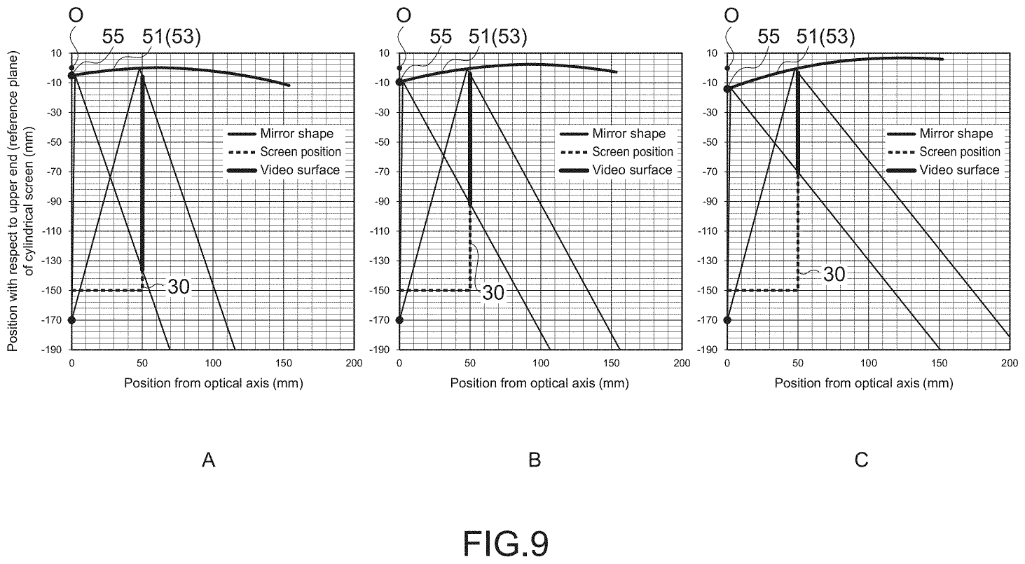

FIG. 8 is a table showing design parameters of the reflection mirror 50 illustrated in FIG. 7. FIG. 9 is a schematic diagram illustrating optical paths of image light when using the design parameters illustrated in FIG. 8. FIG. 8 illustrates design parameters B1 to B3 of the reflection mirror. FIG. 9A to FIG. 9C are schematic diagrams illustrating optical paths of the image light and reflection surfaces 51 (parabolas 53) when using the design parameters B1 to B3.

In accordance with the design parameters B1, B2, and B3, rotation angles (of the parabola 53 and positions of the vertices 55 on the optical axis 1 (shift amounts ΔY in the Y direction) are set in a manner that incident angles of the image light are approximately 70 degrees, approximately 60 degrees, and approximately 50 degrees, respectively. Note that, FIG. 8 illustrates Y-coordinates of the vertex 55 on the basis of the origin O (the intersection between the optical axis 1 and the reference plane 34).

In addition, with regard to the design parameters B1 to B3, the radius r of the screen 30 is 50 mm, the height h of the screen 30 is 150 mm, and the focal length f of the parabola 53 is 170 mm. Note that, the positions of the light source 23 and emission angles (angles of view) of the image light are fixed.

In the case of the design parameter B1, a rotation angle Φ of the parabola 53 is 10 degrees, and a shift amount ΔY of the vertex 55 in the Y direction is −5.08 mm. The incident angles of the image light are set to approximately 70 degrees when using the above-described parabola 53. When using the design parameter B1, the height of the image is 130.7 mm, and the display position of the image is −71.0 mm.

In the case of the design parameter B2, a rotation angle Φ of the parabola 53 is 15 degrees, and a shift amount ΔY of the vertex 55 in the Y direction is −9.59 mm. The incident angle of the image light is set to approximately 60 degrees when using the above-described parabola 53. When using the design parameter B2, the height of the image is 88.3 mm, and the display position of the image is −47.9 mm.

In the case of the design parameter B3, a rotation angle Φ of the parabola 53 is 20 degrees, and a shift amount ΔY of the vertex 55 in the Y direction is −14.29 mm. The incident angles of the image light are set to approximately 50 degrees when using the above-described parabola 53. When using the design parameter B1, the height of the image is 67.8 mm, and the display position of the image is −36.7 mm.

As described above, it is easily control values of the incident angles of the image light 21 by changing the inclination angle (rotation angle Φ) of the parabola 53 with respect to the optical axis 1. Note that, the rotation angle Φ of the parabola 53, the shift amount ΔY in the Y direction, and the like are not limited. They may be appropriately set in accordance with a desired image size, an image position, and the like.

In addition, the present disclosure is not limited to the case where the vertex 55 of the parabola 53 is disposed on the optical axis 1. The vertex 55 may be shifted in the left-right direction (X direction). In other words, the axis may be shifted and rotated in a manner that the axis 54 of the parabola 53 is shifted and the axis 54 of the parabola 53 is rotated. Even in this case, it is also possible to obtain the reflection surface 51 that controls the incident angles of the image light 21 incident on the screen 30 in a manner that the incident angles are substantially fixed. When the axis is shifted and rotated, it is possible to design the reflection mirror 50 having desired functions, in accordance with the shape and the like of the screen 30, for example.

With reference to the configuration of the image display device 100, the image light 21 is radiated to the screen 30 at a wide angle because the incident angles are widened as illustrated in FIG. 6, FIG. 9, and the like. As a result, it is possible to widen a radiation range of the image light 21. As a result, for example, it is possible to display an image on the whole range from the top end to the bottom end of screen 30, and it is possible to fully exert characteristics of the whole circumference screen.

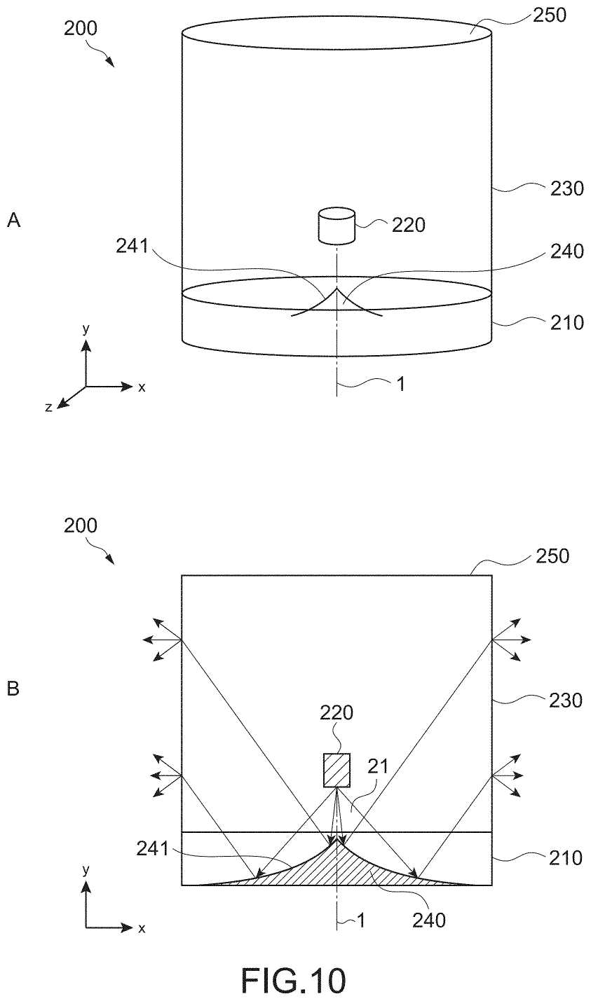

FIG. 10 is an overview diagram illustrating another configuration example of the image display device. FIG. 10A is a perspective view of an appearance of an image display device 200. FIG. 10B is a cross-sectional view that schematically illustrates a configuration of the image display device 200. The image display device 200 includes a base 210, an emission portion 220, a screen 230, and a reflection mirror 240. In the image display device 200, the reflection mirror 240 is disposed at a lower side of the device.

The base 210 has a cylindrical shape, and the base 10 is disposed at the lower side of the image display device 200. The emission portion 220 is disposed above a substantially center of the cylindrical base 210 in a manner that the emission portion 220 faces downward. For example, the emission portion 220 is held by a jig (not illustrated) or the like at a position separated from the base 210. The Jig is connected to an upper side (ceiling 250) of the image display device 200. The screen 230 has a cylindrical shape, and the screen 30 is disposed above the base 210 on the basis of the optical axis 1 of the emission portion 220. The reflection mirror 240 is disposed in the base 210 on the basis of the optical axis 1 in a manner that a reflection surface 241 faces the emission portion 220.

The reflection surface 241 includes a rotation surface obtained by rotating a curve around the optical axis 1. The curve is obtained by cutting out a part of a parabola. For example, in FIG. 10B, a curve constituting a cross-sectional shape of a right side of the reflection surface 241 is obtained by cutting out a part of the parabola whose vertex faces downward. The right side of the reflection surface 241 is across the optical axis 1 from a left side of the reflection surface 241. The reflection surface 241 is a rotation surface obtained by rotating the cutout part (curve) of the parabola around the optical axis 1.

As illustrated in FIG. 10B, in the image display device 200, the emission portion 220 emits the image light 21 downward, that is, toward the reflection mirror 240. The emitted image light 21 is reflected upward by the reflection surface 241, and is incident on the screen 230 at a substantially fixed incident angles. The image light 21 incident on the screen 230 is transmitted and scattered toward the outside, and a whole circumference image or the like is displayed on the outside of the screen 230.

As described above, it is possible to display the whole circumference image or the like while controlling the incident angles of the image light 21 even in the case where the emission portion 220 that is disposed at the upper side emits the image light 21 toward the reflection mirror 240 that is disposed at the lower side.

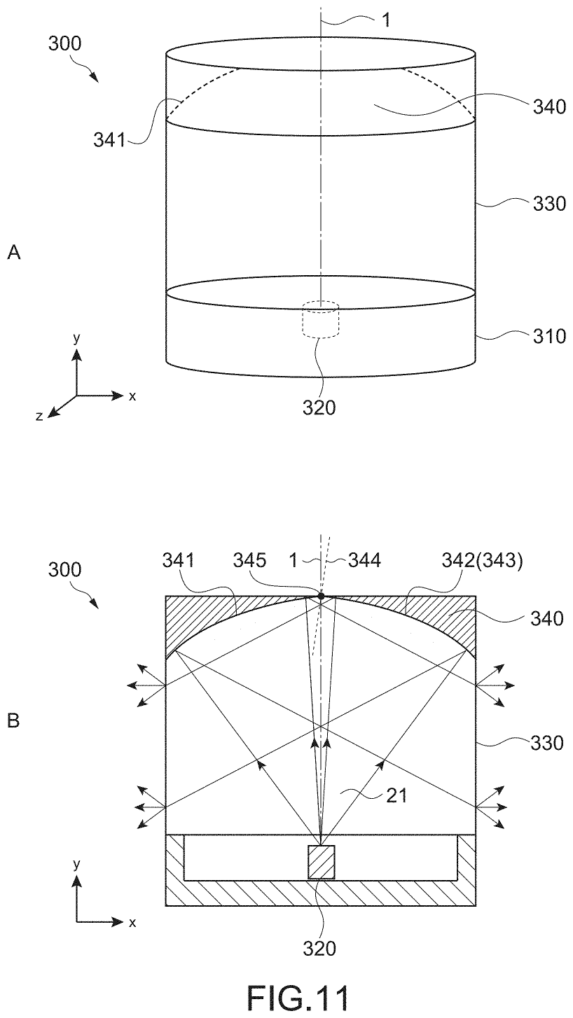

FIG. 11 is an overview diagram illustrating another configuration example of the image display device. FIG. 11A is a perspective view of an appearance of an image display device 300. FIG. 11B is a cross-sectional view that schematically illustrates a configuration of the image display device 300. The image display device 300 includes an emission portion 320, a screen 330, and a reflection mirror 340. The emission portion 320 and the screen 330 are configured in a way similar to the emission portion 20 and the screen 30 illustrated in FIG. 1.

The reflection mirror 340 is disposed on the basis of the optical axis 1 in a manner that the reflection surface 341 faces the emission portion 320 and the reflection mirror 340 faces the emission portion 320. The reflection surface 341 includes a rotation surface obtained by rotating a curve 342 around the optical axis 1. The curve 342 is obtained by cutting out a part of a parabola 343. In the example illustrated in FIG. 11B, the center of the reflection surface 341 (an intersection with the optical axis 1) is concave. In other words, with regard to the reflection surface 341, an intersection between the rotation surface and the optical axis 1 is concave when viewed from the emission portion 320.

In the example illustrated in FIG. 11B, the parabola 343 whose vertex 345 faces upward is used as the curve 342 constituting a cross-sectional shape of the reflection surface 341. The parabola 343 that is convex upward is rotated around the vertex 345 in a rotation axis direction in a state where the axis 344 of the parabola 343 is identical to the optical axis 1. The rotation axis direction is a normal direction of the cross section. In this case, a line segment (parabola 343) is used as the curve 342 constituting the reflection surface 341. The line segment extends downward when viewed from the vertex 345. In FIG. 11B, the reflection surface 341 is obtained by rotating the line segment (curve 342) around the optical axis 1. The line segment connects the vertex 345 and the screen 330.

The present disclosure is not limited to the case of using the parabola 343 rotated in the cross section. It is also possible to use another way to set the curve 342 constituting the reflection surface 341. For example, it is also possible to use the parabola 343 that faces upward and that has the axis shifted with respect to the optical axis 1. In this case, a line segment is used as the curve 342 constituting the reflection surface 341. The line segment is positioned below an intersection between the parabola 343 and the optical axis 1. In addition, for example, it is also possible to set the curve 342 constituting the reflection surface 341 by shifting the vertex 345 of the parabola 343 rotated in the cross section.

As illustrated in FIG. 11B, for example, the image light 21 emitted from the emission portion 320 toward an upper right side is incident on a right side of the reflection surface 341. The upper right side is across the optical axis 1 from an upper left side. The image light 21 incident on the right side of the reflection surface 341 is reflected toward a lower left side and is incident on a left side of the screen 330 at substantially fixed incident angles. In a similar way, the image light 21 reflected by the left side of the reflection surface is incident on the right side of the screen 330 at the substantially fixed incident angles.

As described above, even in the case of using the concave reflection mirror 340, it is possible to control the incident angles of the image light 21 that is incident on the screen 330 by appropriately configuring the reflection surface 341 using the parabola 343. For example, this makes it possible to prevent a protrusion from being seen through the transmissive screen. Examples of the protrusion include the vertex and the like of the reflection mirror 340. Therefore, it is possible to naturally display the image.

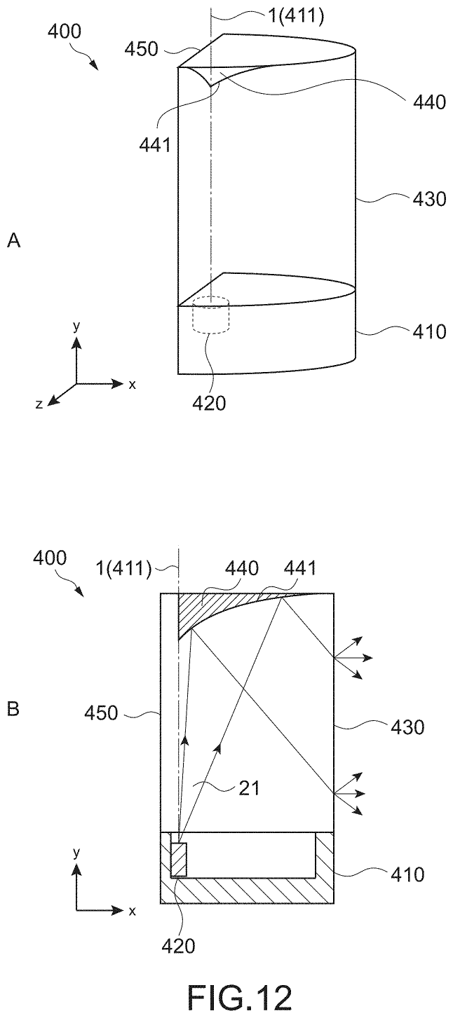

FIG. 12 is an overview diagram illustrating another configuration example of the image display device. FIG. 12A is a perspective view of an appearance of an image display device 400. FIG. 12B is a cross-sectional view that schematically illustrates a configuration of the image display device 400. The image display device 400 includes a base 410, an emission portion 420, a screen 430, and a reflection mirror 440.

The base 410 has a shape that is obtained by cutting a cylindrical shape along a plane (cut surface 450) parallel to a central axis 411 in a manner that the central axis 411 is located internally. For example, when the base 410 is viewed from above the central axis 411, the base 410 has a shape that is cut along an extension direction (z direction in FIG. 12) of a diameter that is orthogonal to a shift direction at a position shifted from the center (the position of the central axis 411) along a predetermined direction (x direction in FIG. 12). In FIG. 12, the cut surface 450 of the cylindrical shape is a plane parallel to a YZ plane.

The emission portion 420 is disposed upward in the base 410 in a manner that the optical axis 1 is substantially identical to the central axis 411 positioned in the base 410. The screen 430 is an arc-like screen, and is disposed in a manner that the screen 430 surrounds the optical axis 1 (central axis 411). The screen 430 is connected to an upper end of the base 410. The reflection mirror 440 is disposed on the basis of the optical axis 1 in a manner that the reflection mirror 440 faces the emission portion 420 and a reflection surface 441 faces the emission portion 420.

The reflection surface 441 has a shape that is obtained by cutting a rotation surface along a plane parallel to the YZ plane including the optical axis 1. The rotation surface is obtained by rotating a curve around the optical axis 1. The curve is obtained by cutting out a part of a parabola. With regard to the reflection surface 441, an intersection between the rotation surface (reflection surface 441) and the optical axis 1 protrudes upward when viewed from the emission portion 420, and a vertex of the reflection surface 441 is disposed on the optical axis 1. For example, it is possible to obtain the reflection surface 441 by cutting the rotationally symmetric reflection surfaces 41 and 51 described with reference to FIG. 5 and FIG. 8, along the plane parallel to the YZ plane including the optical axis 1.

FIG. 12B illustrates a cross section of the image display device 400 taken along a direction of the plane that includes the optical axis 1 and that is parallel to a YX plane. As illustrated in FIG. 12B, the image light 21 emitted from the emission portion 420 toward an upper right side is incident on the reflection surface 441. The image light 21 incident on the reflection surface 441 is reflected toward a lower right side and is incident on the screen 430 at a substantially fixed incident angles. The image light 21 incident on the screen 430 is transmitted and scattered toward the outside, and an image is displayed on the outside of the screen 430.

Note that, the image light 21 emitted across the optical axis 1 toward the upper left side is appropriately adjusted by using a shielding portion or the like in a manner that the image light 21 is not reflected by the arc-like screen 430 and the like. The shielding portion is configured to block the image light 21, for example. Note that, the present disclosure is not limited to the case where the image light 21 is blocked. For example, it is also possible to project only a necessary region of the image by appropriately controlling image signals of the projection image. For example, when the image is projected by using a half of an angle of view of the emission portion 420, it is possible to reduce reflection and the like of unnecessary image light.

As described above, it is also possible to display the image and the like on the arc-like screen 430 while controlling the incident angles of the image light 21. Therefore, for example, it is possible to install a semicylindrical screen or the like near a wall, and it is possible to display a three-dimensional image or the like in a compact display space.

In addition, as the arc-like screen 430, it is also possible to use a reflection screen that reflects the image light 21. In this case, the image is displayed inside the screen 430 (on the optical axis 1 side). For example, when transparent material such as glass or acrylic is used for a flat surface (cut surface 450) that is opposed to the arc-like curved surface (screen 430), it is possible for users at the flat surface (cut surface 450) side to enjoy an image displayed inside the screen 430 via the transparent material. Of course, it is also possible to configure the screen 430 in a manner that the transparent material or the like is not interposed between the users and the screen 430.

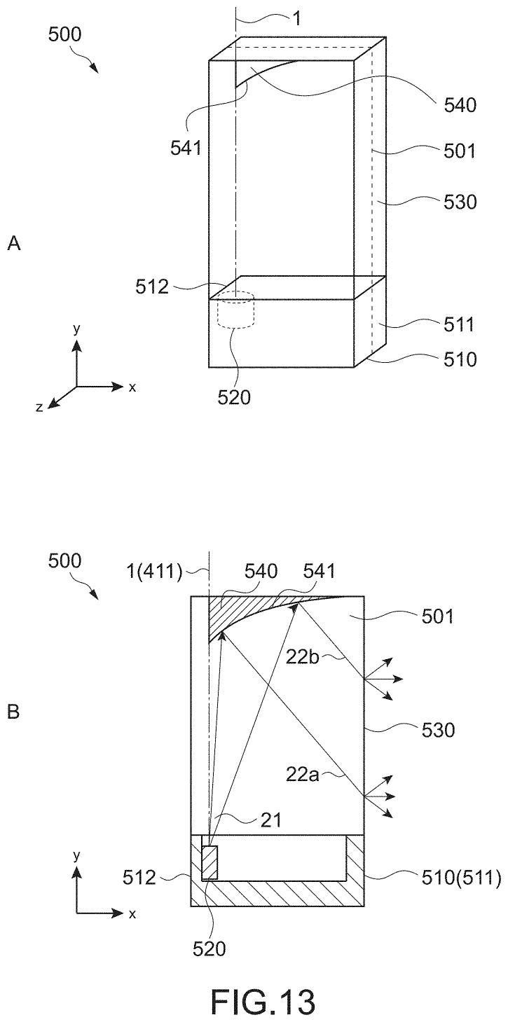

FIG. 13 is an overview diagram illustrating another configuration example of the image display device. FIG. 13A is a perspective view of an appearance of an image display device 500. FIG. 13B is a cross-sectional view that schematically illustrates a configuration of the image display device 500. The image display device 500 includes a base 510, an emission portion 520, a screen 530, and a reflection mirror 540.

The base 510 has a rectangular cuboid shape, and the base 10 is disposed at the lower side of the image display device 500. The base 510 includes a front surface 511 that is parallel to the up-down direction (Y direction), and a rear surface 512 that is opposed to the front surface. In FIG. 13, an X axis, a Y axis, and a Z axis are set in a manner that the front surface 511 (the rear surface 512) is parallel to the YZ plane. The emission portion 520 is disposed at substantially the middle of the rear surface 512 side in the base 510 in a manner that the emission portion 520 faces upward. The screen 530 has a rectangular shape that is parallel to the YZ plane. The screen 530 is disposed above the front surface 511 of the vase 510. The reflection mirror 540 is disposed on the basis of the optical axis 1 in a manner that the reflection mirror 440 faces the emission portion 520 and a reflection surface 541 faces the emission portion 520.

The reflection surface 541 is configured to convert the image light 21 emitted from the emission portion 520 in a predetermined angle range (angle of view) into substantially parallel light fluxes, and emit (reflect) the substantially parallel light fluxes toward the screen 530. In other words, the beams of image light 21 are reflected along substantially the same directions toward the screen 530 at incident points on the reflection surface 541 on which the beams of image light 21 are incident.

As illustrated in FIG. 13B, a cross-sectional shape of the reflection surface 541 taken along a plane (hereinafter, referred to as a central plane 501) that includes the optical axis 1 and that is parallel to the YX plane is configured to include a line segment obtained by cutting out a part of a parabola whose vertex faces upward. Note that, an axis of the parabola is set in a manner that the axis of the parabola is different from the optical axis 1.

A cross-sectional shape of the reflection surface 541 taken along another plane that is parallel to the central plane 501 is appropriately designed in accordance with a distance from the central plane 501 (depth) or the like on the basis of a parabola on the central plane 501, for example. For example, cross-sectional shapes are designed in a manner that the image light 21 is reflected through optical paths at respective depths (respective positions in the z direction). The optical paths are substantially the same as the optical paths 22a and 22b illustrated in FIG. 13B. Of course, the present disclosure is not limited thereto. Any method can be used as long as the reflection surface 541 is obtained.

For example, with regard to vectors that represent emission directions of respective pixels constituting the image light 21, it is possible to use a method of calculating fine reflection surfaces that reflect the respective vectors toward desired directions. In this case, it is possible to obtain the whole reflection surface 541 by simulating fine reflection surfaces while setting Z components (depth components) of the vectors to zero, and setting ratios between X components and Y components to be substantially fixed, for example.

As illustrated in FIG. 13B, the image light 21 emitted from the emission portion 520 toward an upper right side is incident on the reflection surface 541. The image light 21 incident on the reflection surface 541 is reflected toward a lower right side and is incident on the screen 530 at a substantially fixed incident angles. The image light 21 incident on the screen 530 is transmitted and scattered toward the outside, and an image is displayed on the outside of the screen 530. As described above, by appropriately configuring the reflection mirror 540, it is also possible to display the image and the like on the flat screen 530 while controlling the incident angles of the image light 21.

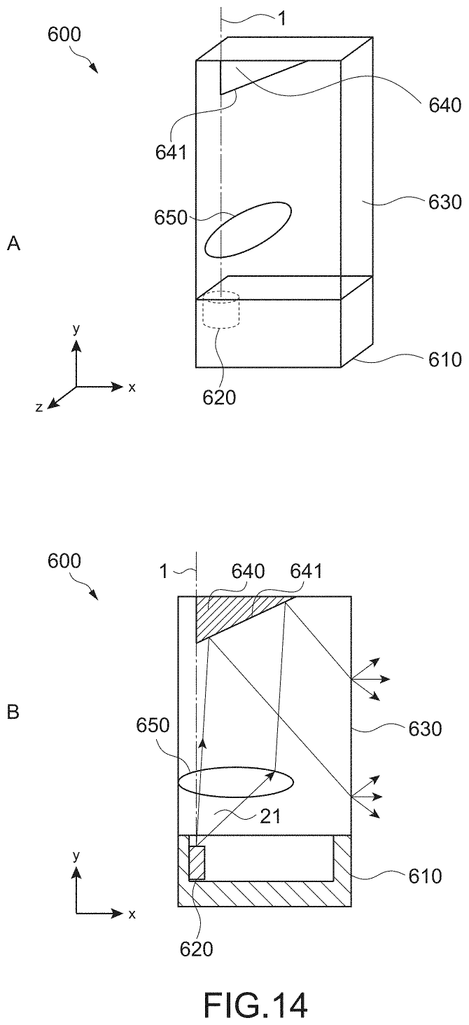

FIG. 14 is an overview diagram illustrating another configuration example of the image display device. FIG. 14A is a perspective view of an appearance of an image display device 600. FIG. 14B is a cross-sectional view that schematically illustrates a configuration of the image display device 600. The image display device 600 includes a base 610, an emission portion 620, a screen 630, a collimator optical system 650, and a reflection mirror 640. Note that, the base 610, the emission portion 620, and the screen 630 are configured in a way similar to the base 510, the emission portion 520, and the screen 530 illustrated in FIG. 13, respectively.

The collimator optical system 650 is disposed on optical paths of the image light 21 emitted from the emission portion 620, on the basis of the optical axis 1 of the emission portion 620. The collimator optical system 620 collimates beams of the image light 21 emitted from the emission portion 620 in a predetermined angle range (angle of view), and emits the collimated beams of the image light as substantially parallel light beams toward the reflection mirror 640. The specific configuration and the like of the collimated optical system 650 are not limited. For example, a collimator lens or the like is used appropriately.

The reflection mirror 640 is disposed in an upper side of the image display device 600 on the basis of the optical axis 1 in a manner that a reflection surface 641 faces the collimator optical system 650. The reflection surface 641 has a flat rectangular shape. The reflection surface 641 is disposed in a manner that the reflection surface 641 is inclined at a predetermined inclination angle with respect to the Z direction in a state where the reflection surface 641 is parallel to the horizontal direction, and in a manner that the reflection surface 641 faces the screen 630.

As illustrated in FIG. 14B, the image light 21 emitted from the emission portion 620 toward an upper right side is incident on the collimator optical system 650. The beams of image light 21 incident on the collimator optical system 650 are emitted as substantially parallel light beams toward the reflection surface 641. The beams of image light 21 that are the substantially parallel light beams are reflected by the flat reflection surface 641, and are incident on the screen 630 while keeping parallel to each other. Therefore, the image light 21 is incident on the screen 630 at the substantially fixed incident angles.

As described above, by using both the collimator optical system 650 and the flat reflection mirror 640, it is possible to control the incident angles of the image light 21 with respect to the screen 630 in a manner that the incident angles are substantially fixed. In the example illustrated in FIG. 14, the collimator optical system 650 and the reflection mirror 640 operate in cooperation with each other, and the collimator optical system 650 and the reflection mirror 640 function as an optical portion that controls the incident angles of the image light 21 emitted from the emission portion, with respect to the irradiation target.

As described above, in the image display devices 100 to 600 according to this embodiment, the image light 21 emitted from the emission portion along the optical axis 1 is incident on the reflection mirror that faces the emission portion. The reflection mirror controls the incident angles of the image light 21 emitted from the emission portion, with respect to the screen. The image light 21 with the controlled incident angles is radiated to the screen disposed at at least a part around the predetermined axis. This makes it possible to display a high-quality image on a whole circumference screen or the like.

As a method of emitting the image light to a screen (such as a cylindrical whole circumference screen) disposed around the optical axis of a projector or the like, it is considered to use a method of reflecting the image light emitted from the projector by a rotation body reflection mirror that is a convex surface, and emitting the image light to the screen. The image light reflected by the convex reflection surface is radiated on the basis of the reflection surface. Therefore, beams of the image light are incident on the screen at different incident angles.

For example, in the case where the hologram screen or the like is used as the screen, there is a possibility that an image is displayed with uneven luminance and colors because the hologram screen has incident angle selectivity and beams of image light with different incident angles have different intensities and the like when they are diffracted. In the case of correcting such unevenness in the image through a signal process, there is a possibility that an amount of the correction gets large and the luminance of the whole image decreases drastically or it is impossible to correct the unevenness in the image, unfortunately.

In addition, as a method of correcting unevenness in an image, it is considered to vary radiation angles of reference light at respective positions and form an interference pattern (multi slants) having different directions when exposing a hologram screen. When using such a multi-slant hologram screen, an angle between the projector or the like and the screen is heavily involved with quality of images. Therefore, alignment may become difficult. In addition, there is a possibility that manufacturing cost increases because a large optical system, a light source having high optical power density, or the like is necessary to vary the radiation angles of the reference light.

With regard to the image display devices 100 to 500 according to the present embodiments, the refection surfaces of the reflection mirrors are configured in a manner that cross-sectional shapes of the planes including the optical axis 1 include concave parabola shapes when viewed from the emission portions. Axes of the parabolas constituting the cross sections of the reflection surfaces are set in a manner that the axes of the parabolas are different from the optical axis 1. Therefore, it is possible to radiate the image light 21 to the screen disposed around the optical axis 1 in a manner that beams of the image light 21 are incident at a substantially fixed incident angles on any position on the screen surface. In addition, similar effects can be exerted when using the collimator optical system like the image display device 600.

Because the incident angles of the image light 21 are controlled in a manner that the incident angles of the image light 21 are substantially fixed, it is possible to sufficiently suppress unevenness and the like of an image due to the incident angle selectivity of the hologram screen, for example. As a result, it is possible to display a high-quality whole circumference image on a whole circumference screen or the like that uses the hologram screen, for example. In addition, correction of image signals and the like is not necessary. Therefore, it is possible to project the image with original radiation intensity of the projector or the like. This makes it possible to display a bright image.

In addition, when exposing the hologram screen, it is possible to obtain an interference pattern by fixing the radiation angles of the reference light. It is possible for such a mono-slant hologram screen to achieve high diffraction efficiency when the image light 21 is incident at the same incident angles as the radiation angles of the reference light (see FIG. 3). For example, it is possible to achieve a transparent display or the like having very high luminance when using a mono-slant transmissive hologram screen for which radiation angles of the reference light are set in accordance with incident angles of the image light 21 that are controlled by the reflection surface.

A manufacturing procedure of the mono-slant hologram screen is simple in comparison with the multi-slant hologram screen. Therefore, it is possible to reduce its manufacturing cost and the like. In addition, in the case of using the mono-slant hologram screen, it is easy to align the screen with respect to the image light because the interference pattern faces a fixed direction, for example. Therefore, when using the mono-slant hologram screen, it is possible to inexpensively manufacture an image display device, and it is easy to do maintenance and the like of such an image display device. In addition, it is possible to sufficiently reduce effects of assembly variation or the like on accuracy of products because the alignment is easy. This makes it possible to provide products with high accuracy.

As described with reference to FIG. 1 and FIG. 11 to FIG. 14, the image light 21 reflected downward by the reflection mirror disposed on the upper side is incident on the screen according to the present embodiment. Therefore, in the case where the transmissive hologram screen or the like is configured in accordance with the incident angles of the image light 21, outside light and the like incident on a display surface of the screen pass through the screen as they are (see FIG. 2).

Accordingly, for example, it is possible to sufficiently suppress a phenomenon in which light of an illumination lamp and the like is reflected on the display surface of the screen, for example. As a result, it is possible to reduce effects of the outside light and the like on the image displayed on the screen, and it is possible to display a sufficiently-high-quality image.

### Second Embodiment

An information processing device according to a second embodiment of the present technology will be described. Hereinafter, description will be omitted or simplified with regard to structural elements and effects that are similar to the image display device described in the above embodiment.

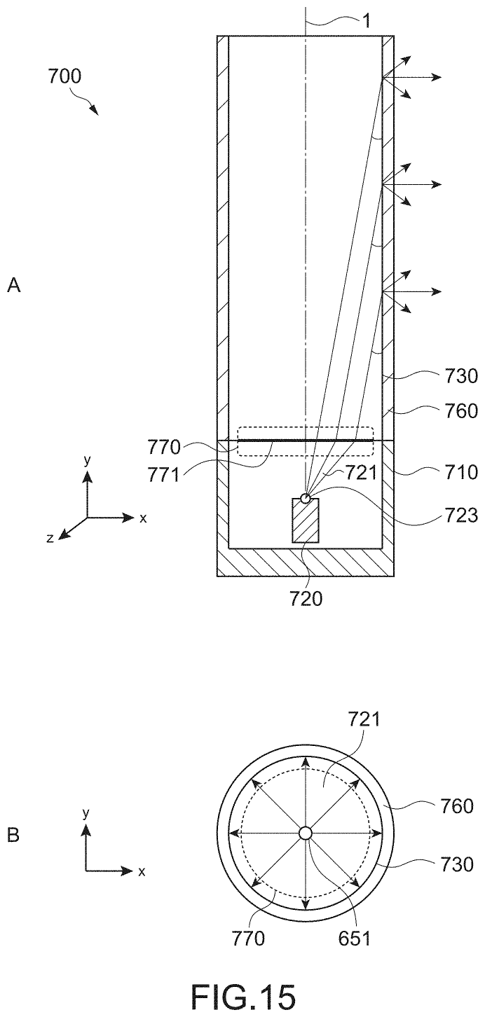

FIG. 15 is an overview diagram illustrating a configuration example of the image display device according to the second embodiment. FIG. 15A is a cross-sectional view that schematically illustrates a configuration of the image display device 700. FIG. 15B is a plan view that schematically illustrates the configuration of the image display device 700 when viewed from above.

The image display device 700 includes a base 710, an emission portion 720, a screen 730, a transparent member 760, and a refraction portion 770. The base 710 has a cylindrical shape, and the base 710 is disposed at a bottom of the image display device 700.

The emission portion 720 is disposed at a substantially center of the cylindrical base 710 in a manner that the emission portion 720 faces upward. FIG. 15A schematically illustrates a situation in which image light 721 is emitted along the optical axis 1 from an emission opening (light source 723) made on an upper side of the emission portion 720. In addition, FIG. 15B schematically illustrates the image light 721 that is radially emitted from the light source 723 (around the optical axis 1). Hereinafter, for ease of explanation, the light source 723 is used as an emission position of the image light 721.

The screen 730 has a cylindrical shape, and the screen 730 includes a transmissive hologram and a light diffusion layer. The transmissive hologram is disposed over the circumference around the optical axis 1. The light diffusion layer is stacked on the outside of the screen (a side opposite to the optical axis 1). The screen 730 is disposed above the base 710 on the basis of the optical axis 1.

The transparent member 760 has a cylindrical shape. The transparent member 760 is provided outside the screen 730 in a manner that the transparent member 760 is in contact with the light diffusion layer of the screen 730. The transparent member 760 functions as a holding mechanism that holds the screen 730. The specific configuration of the transparent member 760 is not limited. For example, the transparent member 760 contains acrylic or the like that is capable of transmitting light.

The refraction portion 770 has a rotationally symmetric shape. The refraction portion 770 is disposed on optical paths of the image light 721 emitted from the emission portion 720 (light source 723) in a manner that a central axis (axis of symmetry) of the refraction portion 770 is identical to the optical axis 1 and the refraction portion 770 faces the emission portion 720. The refraction portion 770 includes one or more refractive surfaces 771 that refract the image light 721 emitted from the emission portion 720.

The one or more refractive surfaces 771 refract the incident image light 721 in a manner that incident angles of the image light 721 emitted from the emission portion 720 are substantially fixed with respect to the screen 730. The number of the refractive surfaces 771, the shapes of the refractive surfaces 771, and the like are not limited. For example, the image light 721 may be refracted by the single refractive surface 771. In addition, the image light 721 may be refracted by two or more refractive surfaces 770 each of which refracts the image light 721. According to the embodiment, the refraction portion 770 corresponds to the optical portion.

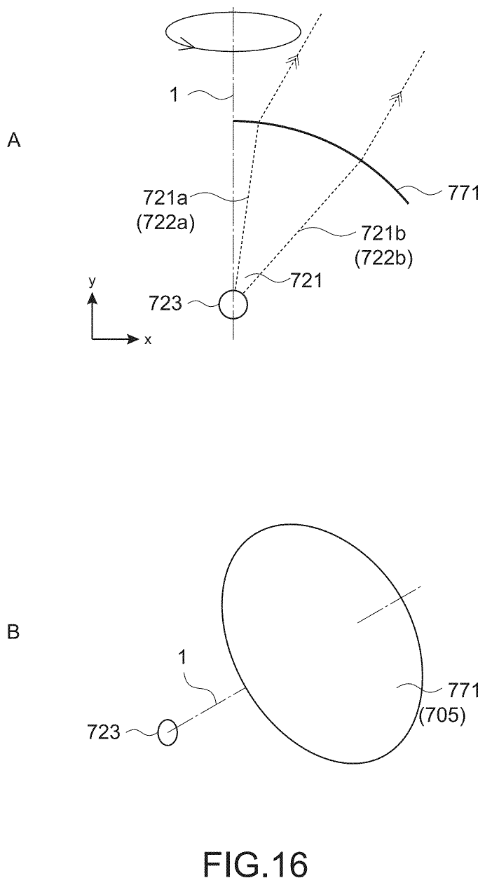

FIG. 16 is a schematic diagram for describing a configuration example of the refractive surface 771. FIG. 16A is a schematic diagram illustrating a cross-sectional shape of the refractive surface 771 on a right side of the optical axis 1 on a plane including the optical axis 1. FIG. 16 B is a schematic diagram of the refractive surface 771 when viewed from an oblique direction. FIG. 16 illustrates the single refractive surface 771.

The refractive surface 771 is formed on a surface of optical material having a predetermined refractive index such as crystal or glass, for example. In general, light incident on the refractive surface 771 is emitted at a fixed emission angle corresponding to an incident angle with respect to the refractive surface 771, the refractive index of the optical material, and the like. For example, the refractive surface 771 is appropriately configured in accordance with optical paths of the image light 721 emitted from the light source 723. Therefore, it is possible to control incident angles of the image light 721 on the refractive surface 771. This makes it possible to control emission angles of the image light 721 from the refractive surface 771 via the respective optical paths, that is, directions of optical paths of refracted light.

FIG. 16A illustrates optical paths (inner optical path 722a and outer optical path 722b) of the image light 721 emitted along a plane (cross section) including the optical axis 1 toward an upper right side of the optical axis 1. For example, image light 721a that passes through the inner optical path 722a is refracted by the refractive surface 771, and emitted along a predetermined direction. In addition, image light 721b that passes through the outer optical path 722b is refracted by the refractive surface 771, and emitted along a direction that is substantially similar to the refraction direction of the image light 721a that passes through the inner optical path 722a. Therefore, the image light 721a that has passed through the inner optical path 722a and the image light 721b that has passed through the outer optical path 722b are refracted by the refractive surface 771 and emitted as substantially parallel light beams. In a similar way, image light 721 that has passed through other optical paths interposed between the inner optical path 722a and the outer optical path 722b is also emitted from the refractive surface 771 as substantially parallel light beams.

As described above, the image light 721 emitted toward the upper right side of the optical axis 1 is refracted by the right side of the refractive surface 771 and is incident on a right side of the screen 730 (not illustrated) as substantially parallel light beams. Therefore, incident angles of the image light 721 is substantially fixed with respect to the right side of the screen 730.

The refractive surface 771 is configured to include a rotation surface 705 obtained by rotating the cross-sectional shape (the right side of the refractive surface 771) illustrated in FIG. 16A around the optical axis 1. FIG. 16B schematically illustrates the refractive surface 771 including the rotation surface 705 centered on the optical axis 1. The image light 721 that is radially emitted from the light source 723 is refracted by the refractive surface 771 illustrated in FIG. 16B and is incident on the screen 730 at substantially fixed incident angles. The image light 721 incident on the screen 730 is transmitted and scattered toward the outside, and a complete works image or the like is displayed on the outside of the screen 730.

Note that, in the case where a plurality of the refractive surfaces 771 is provided, the image light is refracted by the plurality of refractive surfaces 771 and emitted toward the screen 730. In this case, the plurality of refractive surfaces 771 is appropriately configured in a manner that beams of the image light 721 emitted from the refraction portion 770 becomes substantially parallel light beams, that is, in a manner that incident angles of the beams of the image light 721 incident on the screen 730 are substantially fixed.

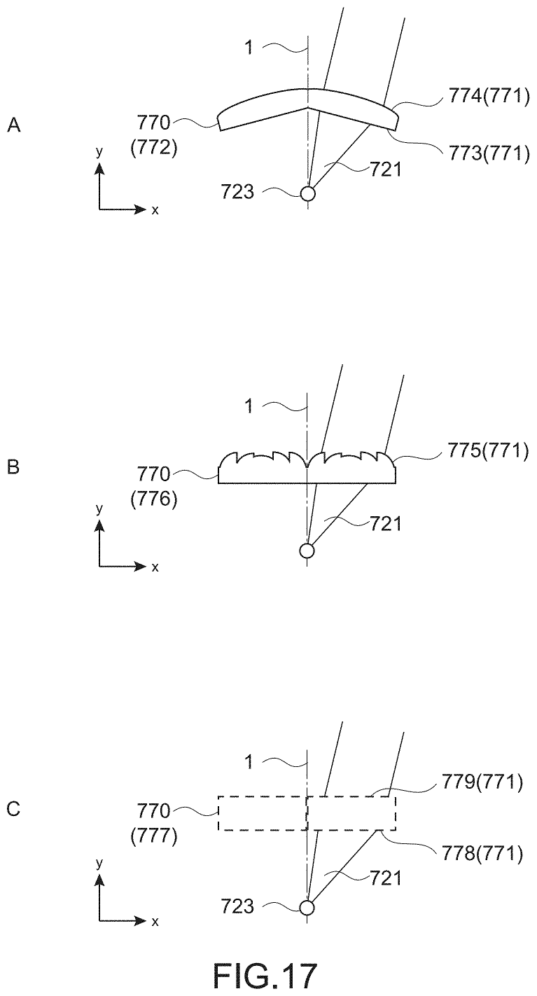

FIG. 17 is a schematic diagram for describing specific configuration examples of the refraction portion 770.

In FIG. 17A, an aspheric lens 772 is used as the refraction portion 770. The aspheric lens 772 includes an aspheric refractive surface 771. The aspheric lens 772 includes a first surface 773 and a second surface 774. On the first surface 773, the image light 721 is incident. The second surface 774 is on a side opposite to the first surface 773. In FIG. 17A, the aspheric lens 772 is configured in a manner that the second surface 774 serves as the aspheric refractive surface 771.

The aspheric refractive surface 771 is configured to have an adjusted aspheric coefficient, an adjusted conic constant, and the like in a manner that incident angles of the image light 721 emitted from the refractive surface 771 is substantially fixed with respect to the screen 730, for example.

As illustrated in FIG. 17A, the image light 721 emitted from the light source 723 is refracted by the first surface 773, passes through the lens, and is incident on the second surface 774. The image light 721 incident on the second surface 774 is refracted by the second surface 774 (the refractive surface 771 on the aspheric surface) and emitted as substantially parallel light beams. In the aspheric lens 772 (refraction portion 770) illustrated in FIG. 17A, the first surface 773 and the second surface 774 function as the one or more refractive surfaces 771.

As described above, it is possible to control the incident angles of the image light 721 on the screen 730 with high accuracy by using the aspheric lens 772 including the aspheric refractive surfaces 771 as the refraction portion 770. Note that, instead of the aspheric refractive surfaces 771, it is possible to use a spherical lens including a spherical refractive surface 771 as the refraction portion 770. This makes it possible to reduce manufacturing cost and the like of the refraction portion 770.

In FIG. 17B, a Fresnel lens 776 including a Fresnel surface 775 is used as the refraction portion 770. The Fresnel surface 775 functions as a refractive surface 771. For example, the Fresnel surface 775 is configured in a manner that incident angles of the image light 721 emitted from the Fresnel surface 775 are substantially fixed with respect to the screen 730. For example, it is possible to thin the thickness of the refraction portion 770 by using the Fresnel lens 776. This makes it possible to reduce the device size.

In FIG. 17C, an optical element 777 is used as the refraction portion 770. The optical element 777 has predetermined refractive-index distribution. The optical element 777 has a cylindrical shape that uses the optical axis 1 as its central axis. The optical element 777 includes a first surface 778 and a second surface 779. On the first surface 778, the image light 721 is incident. The second surface 779 is on a side opposite to the first surface 778. In the optical element 777, the refractive index is adjusted in a manner that the refractive index gradually gets higher from the center portion that is close to the optical axis 1 toward the periphery that is distant from the optical axis 1, for example. Accordingly, the refractive-index distribution of the optical element 777 shows a concentric pattern in which the refractive index increases from the center (the optical axis 1) toward the external side.

The refractive-index distribution is configured in a manner that incident angles of the image light 721 emitted from the second surface 779 are substantially fixed with respect to the screen 730, for example. As illustrated in FIG. 17C, the image light 721 emitted from the light source 723 is refracted by the first surface 778 and the second surface 779 and emitted as substantially parallel light beams from the optical element 777. Accordingly, in FIG. 17C, the first surface 778 and the second surface 779 function as the one or more refractive surfaces 771.

For example, a liquid crystal lens or the like is used as the optical element 777. The liquid crystal lens contains electrically oriented liquid crystal material and controls the refractive indices. This makes it possible to thin the thickness of the refraction portion 770. The specific configuration of the optical element 777 is not limited. For example, any element or the like capable of achieving desired refractive-index distribution is appropriately used as the optical element 777.

Note that, the number of the lenses, elements, and the like that are included in the refraction portion 770 is not limited. For example, the refraction portion 770 may be obtained by appropriately combining the aspheric lens 772, the Fresnel lens 776, the optical element 777, and the like that have been described with reference to FIG. 17A to FIG. 17C. Alternatively, any element may be used as the refraction portion 770.

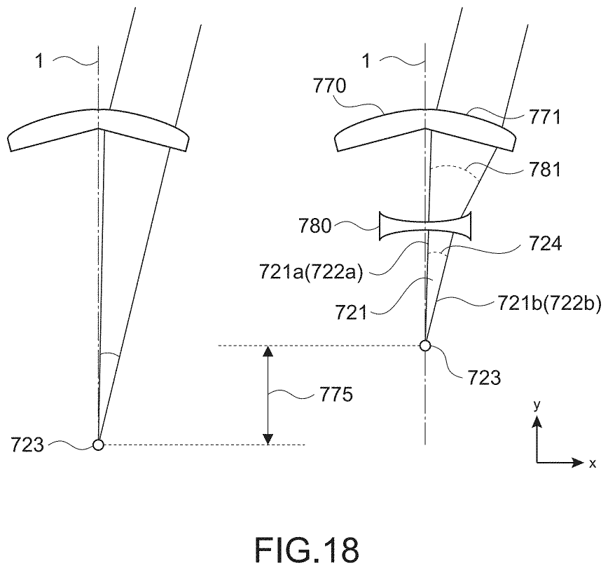

FIG. 18 is a schematic diagram for describing another example of optical paths of the image light 721 from the light source 723 to the refraction portion 770. The right side of FIG. 18 schematically illustrates optical paths of the image light 721 along a plane including the optical axis 1 in the case where a concave lens 780 is disposed. In addition, the left side of FIG. 18 illustrates optical paths of the image light 721 in the case where the concave lens 780 is not used. Note that, FIG. 18 illustrates the aspheric lens as the refraction portion 770. The present disclosure is not limited thereto. The refraction portion 770 may have another configuration.

The concave lens 780 is disposed between the light source 723 and the refraction portion 770 in a manner that the central axis of the concave lens 780 is identical to the optical axis 1. The concave lens 780 magnifies the image light 721 emitted from the light source 723 (the emission portion 720) and emits the magnified light to the refraction portion 770. The specific configuration of the concave lens 780 is not limited. For example, a magnification percentage and the like of the concave lens may be appropriately set in a manner that it is possible to magnify the image light in accordance with the diameter and the like of the refraction portion 770. In this embodiment, the concave lens 780 corresponds to the magnification portion.

The refraction portion 770 is configured in a manner that the incident angles of the image light 721 emitted from the refraction portion 770 are substantially fixed with respect to the screen 730. The refractive surface 771 and the like in the refraction portion 770 are appropriately set in accordance with the installation position (Y-coordinate) of the concave lens 780, the magnification percentage of the concave lens 780, and the like.

As illustrated in FIG. 18, for example, the image light 721a is emitted from the light source 723 along the inner optical path 722a that is close to the optical axis 1, and then the image light 721a is incident on a position near the center of the concave lens 780 and passes through the concave lens while the image light 721a is hardly refracted. In addition, image light 721b is emitted along the outer optical path 722b that is distant from the optical axis 1, and then the image light 721b is incident on a position near the outer circumference of the concave lens 780, and is refracted in a direction that goes away from the optical axis 1.

Therefore, an angle 781 between the emission direction of the image light 721a emitted from the concave lens 780 and the emission direction of the image light 721b emitted from the concave lens 780 is larger than an angle 724 between the emission direction of the image light 721a emitted from the light source 723 and the emission direction of the image light 721b emitted from the light source 723. In other words, an angle of view of the image light 721 is magnified due to the refraction through the concave lens 780. The magnified image light 721 is refracted through the refraction portion 770 and emitted toward the screen 730 as substantially parallel light beams.

As described above, for example, by using the concave lens 780, it is possible to shorten a projection distance in comparison with the case where the concave lens 780 is not used (the left side of FIG. 18). The projection distance is necessary for widening an irradiation area to which the image light 721 is radiated, to a desired area (such as the area of the refractive surface or the like). As a result, it is possible to shorten the distance between the light source 723 and the refraction portion 770, and it is possible to reduce the device size. FIG. 18 schematically illustrates an arrow that represents a distance 775 shortened by using the concave lens 780.

Note that, the structural elements for magnifying the image light 721 emitted from the light source 723 is not limited to the example illustrated in FIG. 18. For example, it is possible to magnify the image light 721 by combining the concave lens with a convex lens, another lens, or the like. In addition, any optical system or the like may be appropriately used as long as the optical system or the like is capable of magnifying the image light 721.

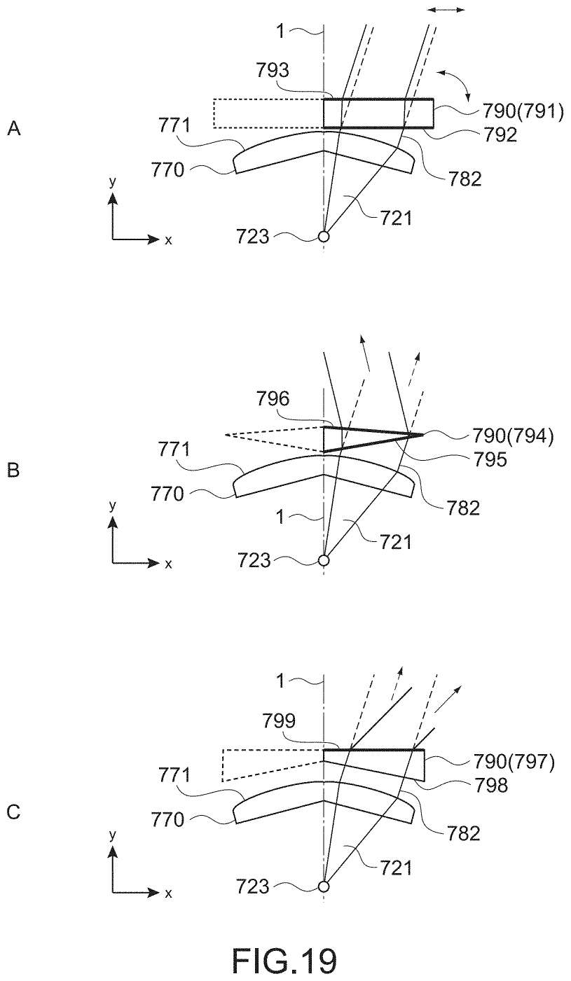

FIG. 19 is a schematic diagram for describing other configuration examples of the optical paths of the image light 721 emitted from the refraction portion 770. In FIG. 19, a prism portion 790 is installed. The prism portion 790 changes optical paths of the image light 721 emitted from the refraction portion 770.

In FIG. 19A, a prism 791 (hereinafter, referred to as a parallel prism 791) is used as the prism portion 790. The parallel prism 791 includes refractive surfaces that are parallel to each other. The parallel prism 791 has a cylindrical shape. The parallel prism 791 includes a third surface 792 and a fourth surface 793. On the third surface 792, the image light 721 is incident. The fourth surface 793 is on a side opposite to the third surface 792. The parallel prism 791 is disposed across the refraction portion 770 from the light source 723 (the emission portion 720) in a manner that the central axis of the cylindrical shape is identical to the optical axis 1.

As illustrated in FIG. 19A, the image light 721 emitted from the light source 723 along a plane including the optical axis 1 is refracted through the refraction portion 770 and emitted as substantially parallel light beams. The image light 721 that is the substantially parallel light beams is incident on the parallel prism 791 at fixed angles, and refracted through the third surface 792. The image light 721 refracted through the third surface 792 is refracted again through the fourth surface 793 that is parallel to the third surface 792, and the refracted image light 721 is emitted at angles similar to the angles of the image light 721 incident on the parallel prism 791.

Accordingly, optical paths 782 of the substantially parallel beams of the image light 721 emitted from the refraction portion 770 are shifted due to the refraction through the parallel prism 791. Shift amounts and the like of the optical paths 782 are decided in accordance with the refractive index and thickness of the parallel prism 791, angles of the image light 721 incident on the parallel prism 791, and the like. Note that, dashed lines in FIG. 19A represents optical paths of the image light obtained in the case where the parallel prism 791 is not provided.

As a result, it is possible to change incident points of the image light 721 on the screen 730, that is, a position of a display region of an image. In the example illustrated in FIG. 19A, the optical paths 782 of the image light 721 are shifted to the inner side (the side in which the optical axis 1 is positioned), and the display region of the image is shifted upward. Note that, the incident angles of the image light 721 on the screen 730 are not changed. Therefore, the size and the like of the image is maintained.

As described above, by using the parallel prism 791 having the refractive surfaces 771 that are parallel to each other, it is possible to easily shift the display position of the image without changing the size, quality, and the like of the image. Note that, it is also possible to configure the parallel prism 791 in a manner that the refractive surfaces (such as the third surface 792 and the fourth surface 793) that are parallel to each other intersect with the optical axis 1 at a predetermined angle on a cross section of the parallel prism 791. In other words, the present technology is also applicable to the case where the refractive surfaces that are parallel to each other are inclined with respect to the optical axis 1.

In FIG. 19B, a prism 791 (hereinafter, referred to as a protruded prism 794) is used as the prism portion 790. The protruded prism 794 includes protruded refractive surfaces. The protruded prism 794 includes a conical refractive surface (fifth surface 795) having a vertex that faces downward, and a conical refractive surface (sixth surface 796) having a vertex that faces upward. The diameter of a base of the conical fifth surface 795 is similar to the diameter of a base of the conical sixth surface 796, and the fifth surface 795 and the sixth surface 796 are connected via their bases. The protruded prism 794 is disposed in a manner that the respective vertices of the fifth surface 795 and the sixth surface 796 intersect with the optical axis 1, and the fifth surface 795 faces the refraction portion 770.

As illustrated in FIG. 19B, substantially parallel beams of the image light 721 are emitted from the refraction portion 770 in a direction (upper right direction in FIG. 19B) that goes away from the optical axis 1, and the substantially parallel beams of the image light 721 are incident on the protruded prism 794. The substantially parallel beams of image light 721 are refracted through the fifth surface 795 and the sixth surface 796 of the protruded prism 794, and are emitted as substantially parallel light beams toward a direction (an upper left direction in FIG. 19B) that gets close to the optical axis 1.

As described above, by using the protruded prism 794, it is possible to change the optical paths (emission directions) of the image light 721 emitted from the refraction portion 770 in a manner that the optical paths face the opposite side across the optical axis 1. Therefore, the image light 721 is incident on the opposite side of the screen 730 across the optical axis 1, and it is possible to drastically shift the display region of the image upward.

In FIG. 19C, a prism 797 (hereinafter, referred to as a recessed prism 797) is used as the prism portion 790. The recessed prism 797 includes a recessed surface. The recessed prism 797 includes a seventh surface 798 and an eighth surface 799. The seventh surface 798 is disposed in a manner that it faces the refraction portion 770. The eighth surface 799 is on a side opposite to the seventh surface 799. The seventh surface 798 is a conically recessed surface that is recessed when viewed from the refraction portion 770. The seventh surface 798 is disposed in a manner that the central axis of the cone is identical to the optical axis 1. The eighth surface is a flat surface that is perpendicular to the optical axis 1.

In the example illustrated in FIG. 19C, the seventh surface 798 is configured in a manner that substantially parallel beams of the image light 721 emitted from the refraction portion 770 are incident on the seventh surface 798, the substantially parallel beams of the image light 721 being substantially perpendicular to the seventh surface 798. Therefore, the image light 721 is hardly refracted through the seventh surface 798.

As illustrated in FIG. 19C, substantially parallel beams of the image light 721 are emitted from the refraction portion 770, and are incident on the seventh surface 798 of the recessed prism 797 in a manner that the substantially parallel beams of the image light 721 are substantially perpendicular to the seventh surface 798. The image light 721 incident on the seventh surface 798 is hardly refracted and is incident on the eighth surface 799. The image light 721 incident on the eighth surface 799 is refracted toward the outer side in a manner that the image light 721 is further away from the optical axis 1 in comparison with the image light 721 incident on the eighth surface 799.

As described above, by using the recessed prism 797, it is possible to change incident angles of the image light 721 that is emitted from the refraction portion 770 and that is incident on the screen 730. In the example illustrated in FIG. 19C, the optical paths of the image light 721 are changed in a manner that the incident angles on the screen 730 become smaller (deeper). Therefore, the image light 721 is emitted toward a lower position of the screen 730, and it is possible to shift the display region of the image downward.

In addition, the incident angles of the image light 721 on the screen 730 are changed while beams of the image light 721 are maintained to be substantially parallel to each other. Accordingly, gaps between the incident points on the screen 730 become smaller, it is possible to reduce the size of an image to be displayed in the up-down direction (Y direction), and it is possible to display the bright image.

The present disclosure is not limited to the examples illustrated in FIG. 19A to FIG. 19C. The shape and the like of the prism included in the prism portion 790 may be set appropriately. For example, to achieve a desired image shift and the like, it is possible to appropriately use a prism capable of changing optical paths of the image light 721 emitted from the refraction portion 770.

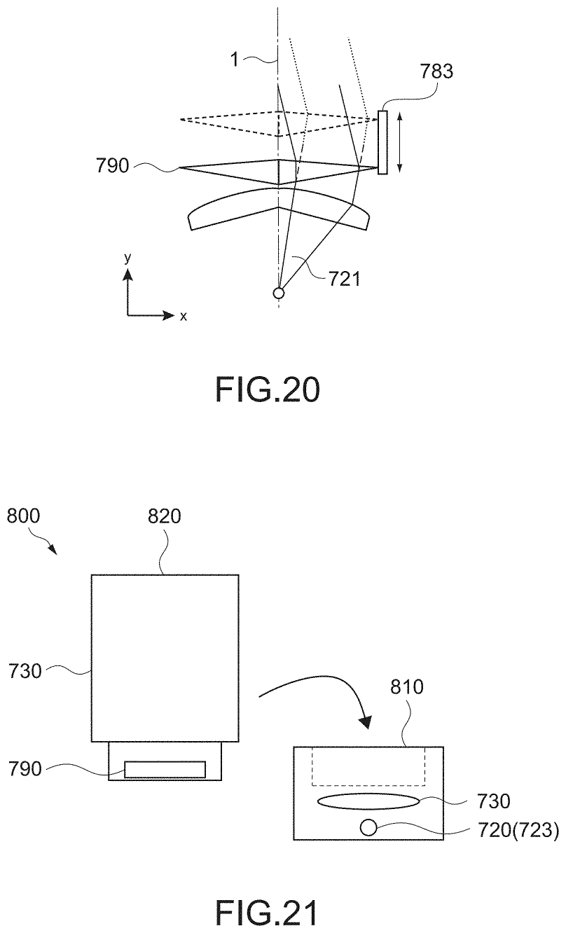

FIG. 20 is a schematic diagram illustrating another example of image shift using a prism. FIG. 20 schematically illustrates an actuator 783 that moves the prism portion 790 upward and downward along the optical axis 1. For example, the actuator 783 is held by a holding mechanism or the like (not illustrated) in the base 710. The specific configuration of the actuator 783 is not limited. For example, any movement mechanism such as a linear stage using a stepping motor or the like, any rotation mechanism using a gear mechanism or the like, etc. may be used.

It is possible to shift the optical paths of the image light 721 upward and downward when shifting the position of the prism 790 upward and downward by using the actuator 783. Therefore, it is possible to shift the incident points of the image light 721 on the screen 730 while maintaining the substantially fixed incident angles of the image light 721 on the screen 730. This makes it possible to adjust the display position of the image upward and downward without changing the size and the like of the image.

FIG. 21 is a schematic diagram illustrating another configuration example of the image display device. An image display device 800 includes a light source unit 910 and a screen unit 820. The light source unit 810 is configured to include the light source 723 (the emission portion 720) and the refraction portion 770, and the light source unit 810 is configured to be capable of emitting the image light 721. The screen unit 820 has a cylindrical shape as a whole, and the screen unit 820 is configured to include the prism portion 790 and the screen 730.

The image display device 800 is used in a state where the screen unit 820 is fitted into the top of the light source unit 810. For example, a plurality of the screen units 820 is configured in a manner that the screens 730 have different widths in the up-down direction, and transmissive holograms used for the screens 730 have different characteristics and the like. It is possible for a user to enjoy whole circumference images and the like with a desired size and quality at a desired position, by selecting a desired screen unit 820 from among the plurality of screen units 820 and mounting it on the light source unit 810.

It is possible to display wide variations of whole circumference images and the like when using the screen units 820 whose screen 730 serves as an attachment to the image display device. In addition, it is possible to simplify alignment of the optical paths of the image light 721 because the light source 723 and the refraction portion 770 are held in the single unit.

As described above, the image display devices 770 and 800 according to the embodiment use the refraction portion 770 that includes the one or more refractive surfaces 771 through which the image light 721 emitted from the emission portion 720 (the light source 723) is refracted. The refraction portion 770 makes it possible to easily control incident angles of the image light 721 on the screen 730.

For example, it is possible to irradiate the transmissive hologram used for the screen 730 with the image light 721 at fixed incident angles. As a result, it is possible to reduce uneven colors and luminance difference in the display region of the image, and it is possible to display a high-quality image on a whole circumference screen or the like. In addition, by setting the incident angles in accordance with the direction and the like of the interference pattern of the transmissive hologram, it is possible to improve image diffraction efficiency of the image light 721 and it is possible to display a bright image. This makes it possible to reduce a burden on a laser light source and the like, and it is possible to achieve a low-power-consumption image display device.

With regard to the image display devices 700 and 800, the emission portion 720, the refraction portion 770, and the like are provided on lower sides of the devices. This makes it possible to display a whole circumference image and the like without deteriorating transparency of the cylindrical screen 730. In addition, it is possible to simply configure the devices because the number of parts to be used in the devices is small. This makes it possible to simplify an assembly process and the like and to reduce manufacturing cost.

### Another Embodiment

The present disclosure is not limited the above-described embodiments. It is possible to achieve various kinds of other embodiments.

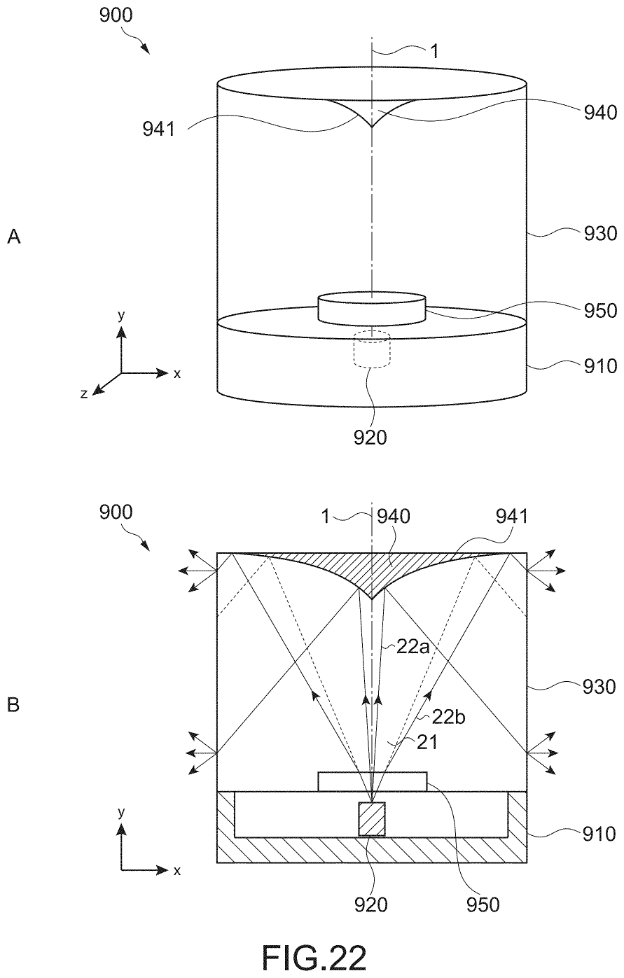

FIG. 22 is an overview diagram illustrating a configuration example of an image display device according to another embodiment. FIG. 22A is a perspective view of an appearance of an image display device 900. FIG. 22B is a cross-sectional view that schematically illustrates a configuration of the image display device 900. The image display device 900 includes a base 910, an emission portion 920, a wide-angle lens 950, a screen 930, and a reflection mirror 940. Note that, for example, the base 910, the emission portion 920, and the screen 930 are configured in a way similar to the base 10, the emission portion 20, and the screen 30 illustrated in FIG. 1, respectively.

The wide-angle lens 950 is disposed above the emission portion 920 and in a manner that the wide-angle lens 950 is disposed on optical paths of the image light 21 emitted from the emission portion 920, on the basis of the optical axis 1 of the emission portion 920. The wide-angle lens 950 magnifies an angle of view of the image light 21 emitted from the emission portion 920 in a predetermined angle range (angle of view). Therefore, the wide-angle lens 950 makes it possible to magnify a radiation area of the image light 21 radiated to the reflection mirror 940.

As the wide-angle lens 950, a conversion lens or the like that magnifies an angle of view of a wide converter lens or the like is used. The present disclosure is not limited thereto. It is possible to use any optical lens or the like as the wide-angle lens 950 as long as the any optical lens or the like is capable of magnifying the angle of view of the image light 21.

The reflection mirror 940 is disposed in a manner that the reflection surface 941 faces the wide-angle lens 950 (the emission portion 920) on the basis of the optical axis 1. The reflection surface 941 reflects the image light 21 in a manner that the image light 21 magnified by the wide-angle lens 950 is incident on the screen 930 at a substantially fixed angle θ.

The reflection surface 941 is designed through the method described with reference to FIG. 4 and FIG. 7, for example. Note that, the position of the light source that is an emission start point of the image light 21 corresponds to parameters of the wide-angle lens 950 (such as magnification, a focal length, and an installation position). The reflection surface 941 is appropriately designed on the basis of such parameters of the wide-angle lens 950 in a manner that the incident angle θ is substantially fixed.

FIG. 22B schematically illustrates an inner optical path 22a and an outer optical path 22b of the image light 21 emitted at an angle of view magnified by the wide-angle lens 950. For example, the outer optical path 22b is bent in a direction that goes away from the optical axis 1 and the emission angle is larger in comparison with an optical path (represented by a dotted line in FIG. 22B) obtained in the case where the image light 21 does not pass through the wide-angle lens 950. Therefore, the image light 21 that has passed through the outer optical path 22b is incident on a position near the periphery of the reflection surface 941 (screen 930 side) in comparison with the case where the image light 21 does not pass through the wide-angle lens 950.

The image light 21 incident on the position near the periphery of the reflection surface 941 is reflected by the reflection surface 941 and is incident on the screen 930 at incident angles θ. For example, in the case where the incident angles θ are similar, the image light 21 reflected at the position near the periphery of the reflection surface 941 is incident on a position closer to an upper end of the screen 930 in comparison with the image light 21 reflected at a position near the center of the reflection surface 941. Therefore, the image light 21 that has passed through the outer optical path 22b is incident on the upper end side of the screen 930 in comparison with the case where the image light 21 does not passes through the wide-angle lens 950. This makes it possible to magnify the size of the image to be projected on the screen 930, in the up-down direction.

In addition, as illustrated in FIG. 22B, the image is projected on a lower side of the screen when using the image light 21 that has passed through optical paths (such as the inner optical path 22a) having a smaller angle of view than the outer optical path 22b. For example, it is possible to set the lower end on which the image is projected, at a position similar to the case where the image light 21 does not pass through the wide-angle lens 950. Therefore, the wide-angle lens 950 makes it possible to magnify the display region of the screen 930 in which the image is displayed, toward the upper end side of the screen 930.

As described above, it is possible to magnify the display region of the whole circumference screen when the radiation area (angle of view) of the image light 21 radiated to the reflection mirror 940 is magnified by using the wide-angle lens 950. Therefore, for example, it is possible to display a whole circumference image in a region from the upper end to the lower end of the screen 930, and this makes it possible to provide powerful video experience or the like.

The first embodiment uses the reflection surface having the cross sectional shape including the curve obtained by cutting out a part of the parabola (see FIG. 1, FIG. 10 to 13, and the like). The shape of the reflection surface of the reflection mirror is not limited to the case where the shape is based on the parabola. For example, the reflection surface may be configured as an aspheric surface (such as a free-form surface) that is different from a paraboloid.

For example, as illustrated in FIG. 1 and the like, distances from the reflection surfaces to the screens are different between the case of the image light incident on the upper end of the screen and the case of the image light incident on the lower end of the screen. In other words, focus positions viewed from the reflection surfaces are different between the upper end and the lower end of the screen. For example, it is possible to design a free-form surface that corrects expansion and the like of the image light depending on the difference in distance. The free-form surface is designed on the basis of optical path simulation or the like, for example. Such a free-form surface enables the whole screen to be irradiated with the image light with high accuracy, and this makes it possible to display a sufficiently-high-quality image.

With regard to the hologram screen (transmissive hologram 31) described with reference to FIG. 2, the object light (diffused light created through the diffuser panel) is emitted from a direction in which the incident angle θ is approximately zero degree, and the interference pattern is exposed. As a result, the reproduction light 3 (image light 21) emitted from the hologram screen is emitted as the diffused light whose strength reaches a peak in a direction parallel to a normal direction of the display surface of the screen. The emission direction of the reproduction light 3 or the like emitted from the hologram screen is not limited to the normal direction.

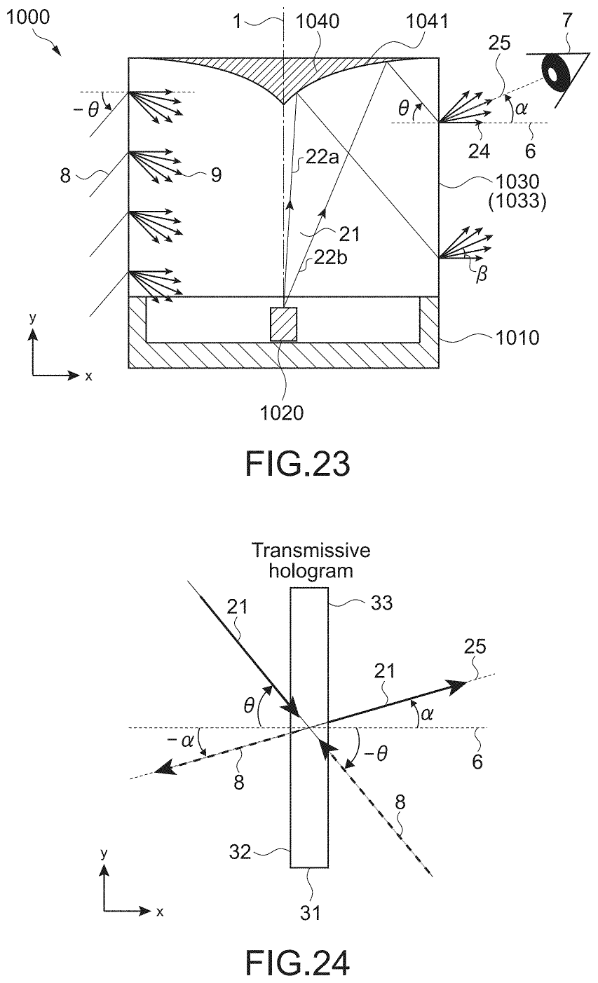

FIG. 23 is an overview diagram illustrating a configuration example of an image display device according to another embodiment. An image display device 1000 includes a base 1010, an emission portion 1020, a screen 1030, and a reflection mirror 1040. Note that, for example, the base 1010, the emission portion 1020, and the reflection mirror 1040 are configured in a way similar to the base 10, the emission portion 20, and the reflection mirror 40 illustrated in FIG. 1, respectively.

The screen 1030 is a transmissive hologram, and functions as a hologram screen. In addition, the screen 1030 emits the image light 21 in a predetermined emission direction, the image light 21 having been incident at an incident angle θ controlled by the reflection mirror 1040. Here, the emission direction is a direction in which the image light 21 is mainly emitted, for example.

In the example illustrated in FIG. 23, the screen 1030 is capable of diffusing and emitting the image light 21. For example, the screen 1030 is configured to diffract the incident image light 21 and emit (diffuse and transmit) the diffracted image light 21 as diffused light 24. In this case, an emission direction 25 is a direction in which the diffused light 24 has the maximum intensity. FIG. 23 schematically illustrates the diffused light 24 by using five arrows representing propagation directions of light beams. Note that, lengths of the respective arrows represent intensities of the light beams. A direction represented by the middle arrow corresponds to the emission direction 25. The middle arrow is the longest among the five arrows.

The emission direction 25 of the screen 1030 is an incident direction of object light on the screen 1030 when the interference pattern is exposed (see FIG. 2). In other words, it is possible to set the emission direction 25 to a desired direction by appropriately setting the incident direction of the object light.

The emission direction 25 is set in a manner that the emission direction 25 intersects with a normal direction 6 of an outer surface 1033 of the screen 1030 at a predetermined intersection angle α. FIG. 23 schematically illustrates a dotted line representing the emission direction 25 and a dotted line representing the normal direction 6 of the outer surface 1033 of the screen 1030. Hereinafter, the outer surface 1033 of the screen 1030 is referred to as the emission surface 133. For example, the emission direction 25 is set in a manner that the emission direction 25 faces a direction that is different from the normal direction 6 of the emission surface 1033. Therefore, for example, the intersection angle α between the emission direction 25 and the normal direction 6 is a finite value represented by a mathematical expression: |α|>0.

In the example illustrated in FIG. 23, the emission direction 25 is set in a manner that the emission direction 25 faces above the normal direction 6. Hereinafter, the intersection angle is +a in the case where the emission direction 25 faces above the screen 1030 on the basis of the normal direction 6, and the intersection angle is −α in the case where the emission direction 25 faces below the screen 1030. In such a way, when the emission direction 25 is +a, it is possible to emit the image light 21 toward a user 7 who is visually recognizing the image display device 1000 (the screen 1030) from an obliquely upward side, for example. Note that, FIG. 23 schematically illustrates an eye of the user 7.

FIG. 24 is a schematic diagram for describing characteristics of the transmissive hologram. The transmissive hologram 31 includes a first surface 32 on which the image light 21 is incident (incident surface of the image light 21), and a second surface 33 that emits the image light 21 (emission surface of the image light 21).

In the example illustrated in FIG. 24, the image light 21 is incident on the first surface 32 from the upper left side at the incident angle θ, and the image light 21 is diffracted through the transmissive hologram 31. The diffracted image light 21 is emitted from the second surface 33 in the emission direction 25 that intersects with the normal direction 6 at +α degrees and that goes upward to the right. Note that, FIG. 24 schematically illustrates a solid arrow representing the image light 21.

In addition, with regard to the transmissive hologram 31, sometimes outside light 8 incident through the second surface 33 is diffracted by the interference pattern. For example, as illustrated in FIG. 24, the outside light 8 is incident on the second surface 33 from the lower right side at the incident angle −θ, and the outside light 8 is diffracted by the transmissive hologram 31. The diffracted outside light 8 is emitted from the first surface 32 at an emission angle −α. Note that, FIG. 24 schematically illustrates a dashed arrow representing the image light 8.

As described above, in contrast to the image light 21, the outside light 8 is incident through the second surface 33 along a direction parallel to an optical path of the image light 21, and is diffracted by the transmissive hologram 31. Next, in contrast to the image light 21, the diffracted outside light 8 is emitted from the first surface 32 along a direction parallel to the emission direction 25 of the image light 21. For example, it is considered that the above described phenomenon may occur in the image display device 1000.

The outside light 8 emitted from the outside of the screen 1030 is schematically illustrated on the left side of FIG. 23. As illustrated in FIG. 23, the outside light 8 is emitted from the lower left side of the screen 1030 at the incident angle −θ, diffracted by the screen 1030, and emitted as outside light components 9 toward the inside of the screen 1030. Here, the outside light components 9 are diffused light obtained by diffracting the outside light 8 through the screen 1030. As described above, the image display device 1000 is set in a manner that the emission direction 25 of the image light faces upward. Therefore, the outside light components 9 are emitted downward.

In addition, with regard to the image display device 1000, the intersection angle α is set on the basis of a diffusion angle β of the image light 21 through the screen 1030. For example, the diffusion angle β (scattering angle) is an angle indicating an emission direction of a light beam whose intensity is 50% of the peak intensity among light beams diffused at a certain point.

In FIG. 23, the diffusion angle R is an angle between a middle arrow in the emission direction 25 and an outermost arrow among the five arrows representing the diffused light 24. Note that, a method or the like of setting the diffusion angle β is not limited. For example, the diffusion angle β may be set on the basis of a value other than 50% of the peak intensity such as 40%, 30%, 60%, or 70% of the peak intensity. Alternatively, any angle representing the expansion of the diffused light 24 may be set as the diffusion angle β.

For example, the intersection angle α may be set in a manner that α=β. In other words, the screen 1030 is configured in a manner that the emission direction 25 faces upward as much as the diffusion angle β. The intersection angle α set in such a way makes it possible to emit most of the outside light components 9 toward a lower side of the device even in the case where the outside light components 9 are diffused light. As a result, by using the outside light components 9 emitted from the screen 1030 on the rear side, it is possible to sufficiently avoid reduction in visibility of the image displayed on the screen 1030 on the front side.

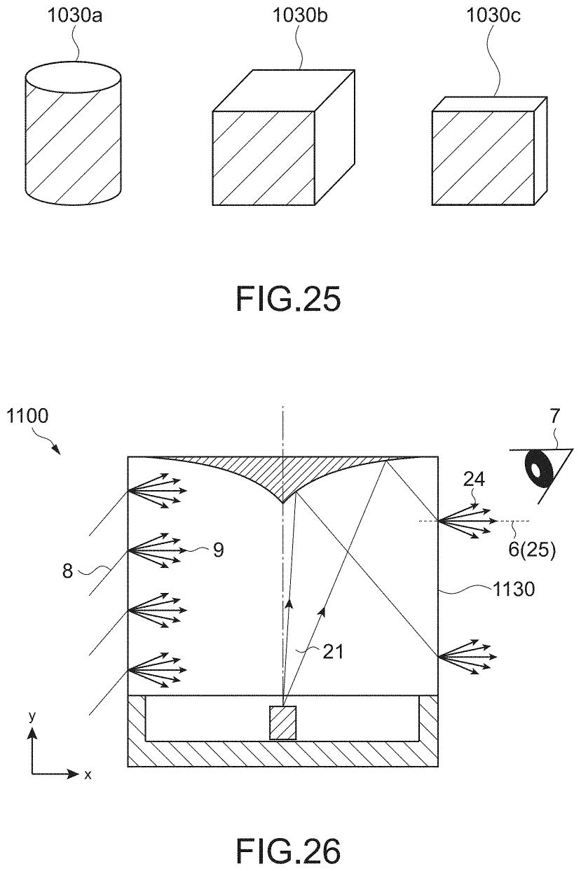

FIG. 25 is a schematic diagram illustrating examples of the shape of the image display device 1000. FIG. 25 schematically illustrates a cylindrical screen 1030a, a block screen 1030b, a plate-like screen 1030c. For example, the transmissive hologram 31 having the intersection angle α makes it possible to emit the image light 21 obliquely upward from a viewing target surface (hatched regions in FIG. 25) visually recognized by a user 1.

In addition, on a surface opposite to the viewing target surface, the outside light 9 is emitted obliquely downward even in the case where light reflected on an installation surface or the like is incident, and this makes it possible to maintain visibility of the image. Of course, similar effects can be obtained even in the case where a position at which the user 7 sees the screen is changed. As described above, the technology described with reference to FIG. 23 and FIG. 24 is applicable to various screen shapes such as the cylindrical screen 1030a, the block screen 1030b, and the plate-like screen 1030c. In addition, the present technology is not limited to the case where the reflection mirror 1040 is used. For example, the transmissive hologram 31 having the intersection angle α is applicable to the configuration including the refraction portion as described in the second embodiment.

As described above, it is possible to efficiently deliver the image light 21 to the user 7 by using the screen 1030 for which the predetermined emission direction 25 is set. As a result, it is possible to improve luminance and the like of the image that the user 7 visually recognizes, and it is possible to display bright images.

FIG. 26 is a schematic diagram illustrating a configuration example of an image display device 1100 according to a comparative example. In the image display device 1100, the emission direction 25 of the diffused light 24 emitted from the screen 1130 is parallel to the normal direction 6. For example, it is assumed that the reflection light (outside light 8) emitted from an installation surface is incident on the screen 1130 at the incident angle −θ. In this case, the screen 1130 (the screen 1130 on the left side of FIG. 26) that is behind a screen 1130 visually recognized by the user 7 emits the outside light components 9 whose peak intensity is in the normal direction 6. For example, the outside light components 9 overlap an image displayed on the screen 130 on the right side. As a result, when using the image display device 1100, sometimes it may be difficult to display adequate colors or luminance.

On the other hand, the image display device 1000 illustrated in FIG. 23 is capable of allowing the diffused light (outside light components 9) and the like of the outside light 8 generated on the screen 1030 on the opposite side to the side visually recognized by the user, to escape to directions that the user 7 does not visually recognize. As a result, it is possible to prevent the extra light from overlapping the image that the user 7 visually recognizes, and it is possible to improve contrast of the displayed image. In addition, the image light 21 is not mixed with the outside light 8. Therefore, it is possible to display an image with clear colors of R, G, and B, for example.

In addition, by setting the emission direction 25 to directions that are expected to be visually recognized by the user 7, it is possible to emit the image light 21 having intensity distribution toward the expected directions, and this makes it possible to improve luminance. As described above, by appropriately setting the emission direction 25, it is possible to prevent the outside light components emitted from the backside screen, from being delivered to the user 7, and it is possible to display an image without lowering visibility. As a result, it is possible to display a sufficiently-high-quality image.

Note that, with reference to FIG. 3, the case where the user 7 visually recognizes the image display device 1000 from the upper side has been described above. The present disclosure is not limited thereto. For example, in the case where the user 7 visually recognizes the image display device 1000 from a lower side, it is possible to suppress effects and the like of the outside light components 9 by lowering the emission direction 25. In addition, the emission direction of the image light 21 may be appropriately set in accordance with an expected usage environment and the like.

In the above described embodiments, the mono-slant hologram screen in which the radiation angles of the reference light are fixed and the interference pattern is exposed, has been described as an example of the HOE. The present disclosure is not limited thereto. The present technology is applicable to the case of using the multi-slant hologram screen.

For example, it is also possible to configure the reflection surface (reflection mirror) in a manner that the image light incident on the screen has a predetermined incident angle distribution. In this case, for example, a multi-slant screen on which the interference pattern (grating) is formed in accordance with the image light incident angle distribution, may be used. This makes it possible to appropriately display an image even in the case where control is performed in a manner that the image light incident angles have distribution.

For example, it is possible to easily widen the display region on the screen when the reflection surface is configured in a manner that the image light expands (diffuses) from the reflection surface toward the screen. In addition, for example, it is possible to improve display luminance on the screen when the reflection surface is configured in a manner that the image light converges from the reflection surface toward the screen. As described above, it is possible to display a high-quality image when controlling of the incident angles by the reflection surface, and the multi-slant screen are appropriately combined.

In the above described embodiments, the screen is configured by using the HOE such as the transmissive hologram. The specific configuration of the screen is not limited thereto. Any screen may be used as long as the screen is capable of displaying the whole circumference image and the like.

For example, a Fresnel screen or the like may be used. The Fresnel screen has a fine Fresnel lens pattern on its surface. In this case, for example, when incident angles of the image light on Fresnel lenses are substantially fixed, it is possible to highly accurately align directions of image light emitted from the screen (Fresnel lenses). As a result, it is possible to sufficiently suppress the uneven luminance and the like, and it is possible to a high-quality image.

In addition, for example, it is possible to use a transparent film or the like as the screen. The transparent film has a light diffusion layer. Even in this case, it is also possible to suppress the uneven luminance and the like associated with difference in the incident angles, by controlling the incident angles of the image light on the light diffusion layer in a manner that the incident angles are substantially fixed. This makes it possible to display an image with even brightness. In addition, material, structures, and the like of parts used for the screen are not limited. For example, the screen may be appropriately configured in accordance with a use purpose, a usage environment, and the like of the image display device.

In the image display devices 100 to 500 according to the first embodiment, the image light 21 emitted from the emission portion is directly incident on the reflection surface. For example, it is also possible to install an optical system such as a lens that magnifies or shrinks the image light 21 or a prism that changes the optical paths of the image light, between the emission portion and the reflection surface.

For example, it is possible to shorten a distance between the emission portion and the reflection surface when disposing a concave lens or the like between the emission portion and the reflection lens and magnifying the image light. In this case, the reflection surface is appropriately configured in accordance with the position, magnification, and the like of the concave lens. This makes it possible to reduce the device size in the up-down direction.

In addition, it is possible to appropriately use any optical system including a lens, a prism, or the like, and a reflection surface configured in accordance with the characteristics of the optical system. In other words, the optical system and the reflection surface may be appropriately combined in a manner that it is possible to control incident angles of the image light on the screen. In this case, the functions of the optical portions according to the present technology are achieved by operating the optical system and the reflection surface in cooperation with each other.

Out of the feature parts according to the present technology described above, at least two feature parts can be combined. That is, the various feature parts described in the embodiments may be arbitrarily combined irrespective of the embodiments. Further, various effects described above are merely examples and are not limited, and other effects may be exerted.

Additionally, the present technology may also be configured as below.

(1) An image display device including:

an emission portion that emits image light along a predetermined axis;

an irradiation target disposed at at least a part around the predetermined axis; and

an optical portion that controls an incident angle of the image light on the irradiation target, the image light having been emitted from the emission portion, the optical portion being disposed in a manner that the optical portion faces the emission portion on the basis of the predetermined axis.

(2) The image display device according to (1),

in which the optical portion sets the incident angle of the image light on the irradiation target to be substantially fixed.

(3) The image display device according to (1) or (2),

in which the optical portion includes a reflection surface that reflects the image light toward the irradiation target, the image light having been emitted from the emission portion.

(4) The image display device according to (3),

in which a cross-sectional shape of the reflection surface taken along a plane including the predetermined axis is configured to include a shape of a parabola that is concave when viewed from the emission portion, and an axis of the parabola is different from the predetermined axis.

(5) The image display device according to (4),

in which, with regard to the reflection surface, the predetermined axis is parallel to the axis of the parabola included in the cross-sectional shape.

(6) The image display device according to (4),

in which, with regard to the reflection surface, the predetermined axis intersects with the axis of the parabola included in the cross-sectional shape, at a vertex of the parabola at a predetermined angle.

(7) The image display device according to any one of (4) to (6),

in which the reflection surface includes a rotation surface obtained by rotating the parabola around the predetermined axis.

(8) The image display device according to (7),

in which, with regard to the reflection surface, an intersection between the rotation surface and the predetermined axis is protruded when viewed from the emission portion.

(9) The image display device according to (7) or (8),

in which, with regard to the reflection surface, an intersection between the rotation surface and the predetermined axis is concave when viewed from the emission portion.

(10) The image display device according to any one of (1) to (9),

in which the optical portion includes one or more refractive surfaces that refract the image light emitted from the emission portion and emits the refracted light toward the irradiation target.

(11) The image display device according to (10), further including

a magnification portion that magnifies the image light emitted from the emission portion and emits the magnified light toward the optical portion, the magnification portion being disposed between the optical portion and the emission portion.

(12) The image display device according to (10) or (11), further including

a prism portion that changes an optical path of the image light emitted from the optical portion, the prism portion being disposed across the optical portion from the emission portion.

(13) The image display device according to any one of (1) to (12),

in which the irradiation target is disposed over a circumference around the predetermined axis.

(14) The image display device according to any one of (1) to (13),

in which the irradiation target is configured to have a cylindrical shape that uses the predetermined axis as its substantially central axis.

(15) The image display device according to any one of (1) to (14),

in which the irradiation target is a hologram screen.

(16) The image display device according to any one of (1) to (15),

in which the irradiation target is any one of a transmissive screen that transmits the image light and a reflective screen that reflects the image light.

(17) The image display device according to any one of (1) to (16),

in which the irradiation target emits the image light in a predetermined emission direction, the image light having been incident at the incident angle controlled by the optical portion.

(18) The image display device according to (17), in which

the irradiation target includes an emission surface that emits the image light, and

the predetermined emission direction intersects with a normal direction of the emission surface at a predetermined intersection angle.

(19) The image display device according to (18), in which

the irradiation target is capable of diffusing and emitting the image light, and

the predetermined intersection angle is set on the basis of a diffusion angle of the image light diffused by the irradiation target.

### REFERENCE SIGNS LIST

1 optical axis
5, 705 rotation surface
20, 220, 320, 420, 520, 620, 720, 920, 1020 emission portion
21, 721 image light
30, 230, 330, 430, 530, 630, 730, 930, 1030 screen
31 transmissive hologram
40, 50, 240, 340, 440, 540, 640, 940, 1040 reflection mirror
41, 51, 241, 341, 441, 541, 641, 941, 1041 reflection surface
43, 53, 343 parabola
44, 54, 344 axis of parabola
770 refraction portion
771 refractive surface
790 prism portion
100 to 800, 900, 1000 image display device

1. An image display device comprising:
an emission portion that emits image light along a predetermined axis;
an irradiation target disposed at at least a part around the predetermined axis; and
an optical portion that controls an incident angle of the image light on the irradiation target, the image light having been emitted from the emission portion, the optical portion being disposed in a manner that the optical portion faces the emission portion on a basis of the predetermined axis,
wherein the optical portion includes a reflection surface that reflects the image light in substantially parallel beams.

2. The image display device according to claim 1,
wherein the optical portion sets the incident angle of the image light on the irradiation target to be substantially fixed.

3. The image display device according to claim 1,
wherein the reflection surface reflects the image light toward the irradiation target, the image light having been emitted from the emission portion.

4. The image display device according to claim 3,
wherein a cross-sectional shape of the reflection surface taken along a plane including the predetermined axis is configured to include a shape of a parabola that is concave when viewed from the emission portion, and an axis of the parabola is different from the predetermined axis.

5. The image display device according to claim 4,
wherein, with regard to the reflection surface, the predetermined axis is parallel to the axis of the parabola included in the cross-sectional shape.

6. The image display device according to claim 4,
wherein, with regard to the reflection surface, the predetermined axis intersects with the axis of the parabola included in the cross-sectional shape, at a vertex of the parabola at a predetermined angle.

7. The image display device according to claim 4,
wherein the reflection surface includes a rotation surface obtained by rotating the parabola around the predetermined axis.

8. The image display device according to claim 7,
wherein, with regard to the reflection surface, an intersection between the rotation surface and the predetermined axis is protruded when viewed from the emission portion.

9. The image display device according to claim 7,
wherein, with regard to the reflection surface, an intersection between the rotation surface and the predetermined axis is concave when viewed from the emission portion.

10. The image display device according to claim 1,
wherein the optical portion includes one or more refractive surfaces that refract the image light emitted from the emission portion and emits the refracted light toward the irradiation target.

11. The image display device according to claim 10, further comprising
a magnification portion that magnifies the image light emitted from the emission portion and emits the magnified light toward the optical portion, the magnification portion being disposed between the optical portion and the emission portion.

12. The image display device according to claim 10, further comprising
a prism portion that changes an optical path of the image light emitted from the optical portion, the prism portion being disposed across the optical portion from the emission portion.

13. The image display device according to claim 1,
wherein the irradiation target is disposed over a circumference around the predetermined axis.

14. The image display device according to claim 1,
wherein the irradiation target is configured to have a cylindrical shape that uses the predetermined axis as its substantially central axis.

15. The image display device according to claim 1,
wherein the irradiation target is a hologram screen.

16. The image display device according to claim 1,
wherein the irradiation target is any one of a transmissive screen that transmits the image light and a reflective screen that reflects the image light.

17. The image display device according to claim 1,
wherein the irradiation target emits the image light in a predetermined emission direction, the image light having been incident at the incident angle controlled by the optical portion.

18. The image display device according to claim 17, wherein
the irradiation target includes an emission surface that emits the image light, and
the predetermined emission direction intersects with a normal direction of the emission surface at a predetermined intersection angle.

19. The image display device according to claim 18, wherein
the irradiation target is capable of diffusing and emitting the image light, and
the predetermined intersection angle is set on a basis of a diffusion angle of the image light diffused by the irradiation target.
